(19) United States
(12) Patent Application Publication
(10) Pub. No.: US 2026/0119784 A1
(43) Pub. Date: Apr. 30, 2026

(54) GENERATING PREDICTED DOCUMENT SUMMARY-CONSISTENCY METRICS USING MACHINE LEARNING MODELS AND AN EXPANDING GRANULARITY ANALYSIS

(71) Applicant: Adobe Inc., San Jose, CA (US)

(72) Inventor: Seunghyun Yoon, Seoul (KR)

(21) Appl. No.: 18/930,606

(22) Filed: Oct. 29, 2024

(51) Int. Cl. G06F 40/166; G06F 40/194; G06F 40/295; G06F 40/30

(52) U.S. Cl. CPC G06F 40/166; G06F 40/194; G06F 40/295; G06F 40/30

(57) ABSTRACT

The present disclosure is directed toward systems, methods, and non-transitory computer readable media that generate a preliminary predicted document-summary consistency portraying elements from a text prompt utilizing a generation diffusion model and refine the preliminary predicted document-summary consistency to generate a predicted document-summary consistency. In particular, the disclosed systems receive, via an interaction with a user device, a text prompt specifying elements to portray within a predicted document-summary consistency. Furthermore, the disclosed systems generate an image generation prompt from the text prompt. Moreover, the disclosed systems utilize the generation diffusion model to generate a preliminary predicted document-summary consistency depicting the elements from the text prompt. In addition, the disclosed systems refine the preliminary predicted document-summary consistency to generate the predicted document-summary consistency.

### BACKGROUND

Advancements in natural language processing and machine learning have led to innovative developments in content processing systems. Current content processing systems can autonomously produce various forms of content based on user inputs or established guidelines, streamlining content creation for a wide range of applications. In addition to generating content, current content processing systems can organize and structure content to align with specific goals or standards. Some content processing systems use deep learning techniques to enhance language processing capabilities, enabling the content processing systems to generate more complex text that closely mimics human language. However, despite these advances, existing systems still face limitations in terms of accuracy, flexibility, and efficiency when evaluating the factual consistency of summaries associated with digital documents.

### SUMMARY

One or more embodiments provide benefits and/or solve one or more of the foregoing or other problems in the art with systems, methods, and non-transitory computer readable storage media that utilize machine learning models to evaluate the factual consistency of summaries of digital documents utilizing a localized and expanded granularity analysis. For example, based on the content of a digital summary of a digital document, the disclosed systems utilize a large language model to generate atomic facts. In some cases, the disclosed systems utilize a natural language inference model to generate localized relationship scores by comparing the atomic facts with sentences of the digital document. In one or more embodiments, the disclosed systems utilize the natural language inference model (or another natural language inference model) to generate granularity expanded relationship scores for a subset of the atomic facts by comparing the atomic facts with adjacent sentence combinations from the digital document. In some cases, based on the localized relationship scores and the granularity expanded relationship scores, the disclosed systems generate a predicted document-summary consistency between the digital summary and the digital document.

### BRIEF DESCRIPTION OF THE DRAWINGS

This disclosure will describe one or more example embodiments of the systems and methods with additional specificity and detail by referencing the accompanying figures. The following paragraphs briefly describe those figures, in which:

FIG. 1 illustrates a schematic diagram of an example environment of a factual inconsistency detection system in accordance with one or more embodiments;

FIG. 2 illustrates an example overview of generating a predicted document-summary consistency from a text prompt utilizing a coreference resolution model, a large language model, and a natural language inference model in accordance with one or more embodiments;

FIG. 3 illustrates an example of generating a coreference resolved digital summary and a coreference resolved digital document utilizing a coreference resolution model in accordance with one or more embodiments;

FIG. 4 illustrates an example of generating atomic facts utilizing a large language model in accordance with one or more embodiments;

FIG. 5 illustrates an example of utilizing a natural language inference model to generate a predicted document-summary consistency in accordance with one or more embodiments;

FIG. 6 illustrates an example of utilizing a graphical user interface to display granular evaluations of digital content utilizing the factual inconsistency detection system in accordance with one or more embodiments;

FIG. 7 illustrates a comparison of the factual inconsistency detection system using various configurations in accordance with one or more embodiments;

FIG. 8 illustrates the results of a comparison of the factual inconsistency detection system with existing systems in accordance with one or more embodiments;

FIG. 9 illustrates a diagram of an example architecture of the factual inconsistency detection system in accordance with one or more embodiments;

FIG. 10 illustrates a flowchart of a series of acts for generating a predicted document-summary consistency for a digital summary of a digital document in accordance with one or more embodiments; and

FIG. 11 illustrates a block diagram of an example computing device in accordance with one or more embodiments.

### DETAILED DESCRIPTION

This disclosure describes one or more embodiments of a factual inconsistency detection system that utilizes machine learning models to evaluate the factual consistency of summaries associated with digital documents utilizing both sentence-level analysis and expanded-sentence analysis of atomic facts. In one or more embodiments, based on sentences from a digital summary of a digital document, the factual inconsistency detection system utilizes a large language model to generate atomic facts representing fine-grained units of information from the digital summary. In some cases, the factual inconsistency detection system utilizes a natural language inference model to generate localized relationship scores by comparing the atomic facts with sentences of the digital document. In one or more embodiments, the factual inconsistency detection system utilizes the natural language inference model (or another natural language inference model) to generate granularity expanded relationship scores by comparing a subset of the atomic facts with sentence combinations from the digital document. In some cases, based on the localized relationship scores and the granularity expanded relationship scores, the factual inconsistency detection system generates overall consistency scores to determine a predicted document-summary consistency between the digital summary and the digital document. In some embodiments, the factual inconsistency detection system provides a user interface for providing a granular evaluation of a document summary.

More specifically, in one or more embodiments, the factual inconsistency detection system utilizes coreference resolution to predict a factual consistency between a digital summary and a digital document. For example, the factual inconsistency detection system utilizes a coreference resolution model to generate a coreference resolved digital summary by performing coreference resolution on a digital summary. In some cases, the factual inconsistency detection system utilizes the coreference resolution model to generate a coreference resolved digital document by performing coreference resolution on a digital document. In this way, the factual inconsistency detection system resolves coreferences within the digital summary and/or the digital document, including resolving instances where different terms, pronouns, or names refer to the same entity. For example, the factual inconsistency detection system replaces pronouns with entity names. In some cases, the factual inconsistency detection system prefixes, or suffixes, adjectives or other descriptive modifies that refer to an entity with the entity name.

As mentioned, in certain embodiments, the factual inconsistency detection system generates atomic facts from the coreference resolved digital summary (and/or the digital summary). For example, the factual inconsistency detection system utilizes a large language model to generate the atomic facts which include fine-grained pieces of information. In some cases, the factual inconsistency detection system prompts the large language model with an atomic fact prompt to decompose each sentence in the coreference resolved digital summary into atomic fact(s).

Furthermore, the factual inconsistency detection system utilizes a natural language inference model to filter the atomic facts. For example, the natural language inference model utilizes the atomic facts to assess whether the content of the digital summary aligns with the coreference resolved digital summary. In some cases, the factual inconsistency detection system utilizes the natural language model to classify the relationship between a premise (e.g., a portion of the digital document) and a hypothesis (e.g., an atomic fact) based on a probabilistic distribution. In particular, the factual inconsistency detection system utilizes the natural language inference model to generate summary relationship scores (e.g., probabilistic scores) including a contradiction score, a neutral score, and an entailment score. Based on the summary relationship scores, the factual inconsistency detection system filters the atomic facts to remove incorrect or irrelevant atomic facts.

In one or more embodiments, the factual inconsistency detection system utilizes the atomic facts (or pre-filtered atomic facts) and the coreference resolved digital document to generate a predicted document-summary consistency measure. For example, the factual inconsistency detection system performs a localized sentence-level analysis and an expanded-sentence analysis utilizing the atomic facts. For the localized sentence-level analysis, the factual inconsistency detection system utilizes a natural language inference model to compare atomic facts to individual sentences of the coreference resolved digital document. In particular, the natural language inference model generates document relationship scores (e.g., probabilistic scores) including contradiction scores, neutral scores, and/or entailment scores. Based on the document relationship scores, the factual inconsistency detection system determines localized relationship scores which represent whether each atomic fact logically follows based on the individual sentences in the coreference resolved digital document.

In some cases, the factual inconsistency detection system further refines the analysis by adaptively increasing the granularity of the premise for the natural language inference model. In some cases, the factual inconsistency detection system determines granularity expanded relationship scores for atomic facts (e.g., in circumstances where the entailment score is less than the contradiction score or the neutral score). In these or other cases, the factual inconsistency detection system determines granularity expanded relationship scores by comparing the atomic facts to multiple sentences from the coreference resolved digital document. In one or more embodiments, the factual inconsistency detection system increases the granularity in this way for atomic facts where the entailment score significantly decreases. For example, based on an expanded-sentence analysis, the factual inconsistency detection system utilizes the natural language inference model to determine granularity expanded relationship scores for a subset of the atomic facts based on document relationship scores (e.g., contradiction scores, neutral scores, and entailment scores).

Moreover, the factual inconsistency detection system determines a predicted document-summary consistency for the comparison of the digital summary with the digital document based on the localized relationship scores and the granularity expanded relationship scores. For example, the factual inconsistency detection system combines the localized relationship scores with the granularity expanded relationship scores to generate overall consistency scores for the atomic facts. In some embodiments, the factual inconsistency detection system generates the predicted document-summary consistency based on comparing the values of the overall consistency scores. In some cases, the factual inconsistency detection system generates the predicted document-summary consistency based on the lowest value of the overall consistency scores. As mentioned, the factual inconsistency detection system generates the predicted document-summary consistency to predict a consistency between the digital summary and the digital document.

As mentioned, existing systems have a number of technical shortcomings, particularly in terms of flexibility, accuracy, and efficiency when evaluating digital summaries associated with digital documents. For example, many existing systems use sentence-level evaluation processes that rely heavily on keyword matching between a summary and a source document and miss context-dependent inconsistencies. To illustrate, if similar keywords are used in both the summary and the document, exiting fact verification models often assume the facts are correct, even when the context of the document indicates their meaning or intent is inaccurate.

Relatedly, existing systems often fail to detect subtle contextual errors, such as a summary that incorrectly attributes an action to a person or misrepresents relationships between events. Indeed, existing systems often incorrectly evaluate summary content. For example, in cases where factual inconsistencies relate to the connection between multiple separated concepts (e.g., cause and effect, sequences of events, or interactions between pieces of information), existing systems often fail to identify the factual inconsistencies. As a result, these exiting systems frequently miss contradictions based on multi-sentence relationships, event timelines, or entity aliases.

In addition, existing systems often inaccurately analyze pronouns or modifiers, leading to incorrect evaluations. To illustrate, although some existing algorithms link pronouns or modifiers to entity names within documents using entity clusters, these algorithms often replace linked terms with the first entity mention in an entity cluster, which may not be an actual entity name (and could be a pronoun or modifier). As a result, if pronouns are used in both a summary and a document, exiting systems often fail to generate correct associations between the pronouns and entities. The problem of incorrect pronoun evaluations is exacerbated by the sentence-level evaluation processes of existing fact verification models because pronouns often depend on preceding or subsequent information in a digital document to provide contextual associations.

Furthermore, existing systems are inflexible and inefficient. For example, many existing systems perform a rigid, one-size-fits-all comparison between a summary and a source document, irrespective of the outcome of the comparison. As mentioned, numerous existing systems limit their evaluations to fixed level comparisons. For example, such fact verification models subdivide entire source documents into pre-determined sizes. Consequently, existing systems perform inflexible and inefficient evaluations of summaries based on static text subdivisions unrelated to the results of the evaluations, expending excess computational resources.

The inaccuracy, inflexibility, and inefficiency of existing systems leads to significant limitations with refining and interpreting the factual inconsistencies within summaries. In particular, existing systems often fail to provide detailed, interpretable data about the inconsistencies between the summary and a source document. For example, existing systems do not offer granular insights into how individual facts from a summary correspond to specific sections of a source document. While existing systems might identify the existence of a general inconsistency, existing systems lack the precision to pinpoint which specific facts are problematic, or how these facts relate to the structure of the document. This inability to granularly break down the analysis into finer details results limits the interpretability, usefulness, and verifiability of these existing systems.

As suggested above, embodiments of the factual inconsistency detection system provide a variety of advantages over conventional systems. For example, in some implementations, the factual inconsistency detection system provides advantages in accuracy over existing systems. Unlike existing systems that rely heavily on keyword matching between a summary and a source document, in one or more embodiments the factual inconsistency detection system utilizes atomic facts to compare a digital summary and a digital document. In particular, in some implementations the factual inconsistency detection system extracts atomic facts (e.g., small units of semantic information) from the digital summary and compares the atomic facts to both individual sentences and expanded-sentence combinations from the digital document. By comparing the atomic facts to the digital document utilizing both localized sentence-level analysis and expanded-sentence analysis with a natural language inference model, the factual inconsistency detection system can identify inconsistencies based on sentence relationships and entity aliases which are often missed by existing systems.

Moreover, in one or more embodiments the factual inconsistency detection system performs coreference resolution on the digital summary and associated digital document to replace terms that refer to the same entity within the text. By performing coreference resolution to replace alternate terms (e.g., pronouns or modifiers) with entity names, in some implementations the factual inconsistency detection system avoids contextual errors overlooked by conventional systems. And, unlike existing algorithms which replace the entity names with the first entity mention in an entity cluster, in some implementations the factual inconsistency detection system replaces entity mentions within an entity cluster with the entity name. Moreover, unlike existing systems which replace adjectives and modifiers with entity names to discard contextual information, in one or more embodiments the factual inconsistency detection system prefixes adjectives and/or modifiers with entity names and retains the information inherent in the adjectives and/or modifiers. In this way, in some implementations the factual inconsistency detection system accurately tracks changes in context within the source document, thereby providing a more robust, nuanced analysis of factual consistency, reducing errors and ensuring a higher level of consistency over existing systems.

In addition, the factual inconsistency detection system provides advantages in flexibility and efficiency over existing systems. Unlike conventional systems that perform one-size-fits-all comparisons between a summary and a source document, in some implementations the factual inconsistency detection system judiciously incorporates an additional analysis for atomic facts that show potential discrepancies, while not performing an additional analysis for atomic facts that do not indicate potential discrepancies. In some cases, the factual inconsistency detection system also efficiently limits the multi-sentence analysis to sentences adjacent to sentences determined to be relevant to the atomic fact using entailment scores. In this way, in one or more embodiments the factual inconsistency detection system also ensures that the computing system does not expend unnecessary computational resources-memory, processing, bandwidth-on unnecessary analysis.

Relatedly, the factual inconsistency detection system provides notable advantages when refining and interpreting factual inconsistencies within the summaries. By adaptively increasing the granularity, in some implementations the factual inconsistency detection system improves the interpretability and reliability of the results. For example, in one or more embodiments the factual inconsistency detection system identifies sentence-level relationships between individual sentences and atomic facts. Furthermore, in some implementations the factual inconsistency detection system performs a multi-sentence analysis and scores relationships between multiple sentences for specific atomic facts. In addition, in one or more embodiments the factual inconsistency detection system generates a predicted document-summary consistency for the factual consistency of the summary with the entire digital document. In this way, implementations of the factual inconsistency detection system can provide a localized sentence-level analysis, an expanded-sentence analysis, and a predicted factual consistency between the digital summary and the digital document (e.g., sentence-level, multi-sentence-level, and document-level analysis).

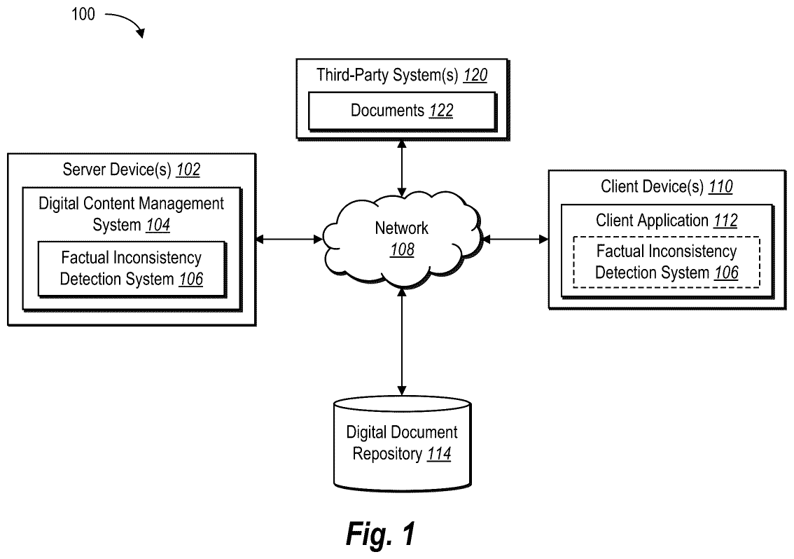

Additional detail regarding the factual inconsistency detection system will now be provided with reference to the figures. For example, FIG. 1 illustrates a schematic diagram of an exemplary system environment (e.g., environment 100) in which a factual inconsistency detection system 106 operates. As illustrated in FIG. 1, the environment 100 includes server device(s) 102, a network 108, client device(s) 110, digital document repository 114, and third-party system(s) 120.

Although the environment 100 of FIG. 1 is depicted as having a particular number of components, the environment 100 is capable of having any number of additional or alternative components (e.g., any number of servers, client devices, or other components in communication with the factual inconsistency detection system 106 via the network 108. Similarly, although FIG. 1 illustrates a particular arrangement of the server device(s) 102, the network 108, the client device(s) 110, the digital document repository 114, and the third-party system(s) 120, various additional arrangements are possible.

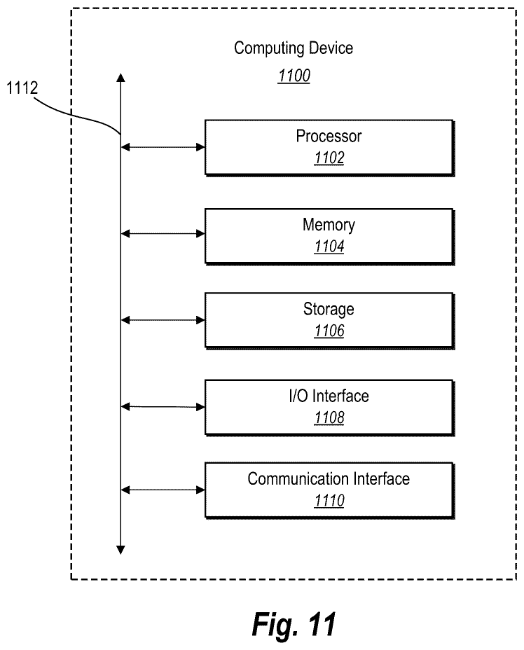

The server device(s) 102, the network 108, the client device(s) 110, the digital document repository 114, and the third-party system(s) 120 are communicatively coupled with each other either directly or indirectly (e.g., through the network 108 discussed in greater detail below in relation to FIG. 11). Moreover, the server device(s) 102 and the client device(s) 110 include one of a variety of computing devices (including one or more computing devices as discussed in greater detail with relation to FIG. 11).

As illustrated in FIG. 1, the environment 100 includes the server device(s) 102 and the digital content management system 104. The server device(s) 102 utilizes the digital content management system 104 to generate, track, store, process, receive, and transmit electronic data including digital summaries, digital documents, overall consistency scores, and a predicted document-summary consistency. For example, the server device(s) 102 receives or monitors interactions across the client device(s) 110. In some embodiments, the server device(s) 102 transmits content to the client device(s) 110 to cause the client device(s) 110 to display content associated with generating the predicted document-summary consistency. For example, the server device(s) 102 presents the predicted document-summary consistency to client device(s) 110 and displays the predicted document-summary consistency on the client device(s) 110 with the predicted document-summary consistency displayed corresponding to system need (e.g., provides predicted document-summary consistency, overall consistency scores, digital summaries, and digital documents for display via the client application 112). The server device(s) 102 further accesses and utilizes the digital document repository 114 to store and retrieve information such as stored digital summaries, digital documents, overall consistency scores, predicted document-summary consistency, and/or other data.

Additionally, the server device(s) 102 includes all, or a portion of, the factual inconsistency detection system 106. For example, the factual inconsistency detection system 106 operates on the server device(s) 102 to access digital content (including digital summaries, digital documents, overall consistency scores, and predicted document-summary consistency), determine digital content changes, and provide localization of content changes to the client device(s) 110. In one or more embodiments, via the server device(s) 102, the factual inconsistency detection system 106 generates and displays digital summaries, digital documents, overall consistency scores, and/or predicted document-summary consistency based on the client device(s) 110 input. Example components of the factual inconsistency detection system 106 will be described below with regard to FIG. 11.

Furthermore, as shown in FIG. 1, the illustrated system includes the client device(s) 110. In some embodiments, the client device(s) 110 include, but are not limited to, mobile devices (e.g., smartphones, tablets), laptop computers, desktop computers, or another type of computing devices, including those explained below in reference to FIG. 11. Some embodiments of client device(s) 110 are operated by a user to perform a variety of functions via client application 112 such as the generation of the predicted document-summary consistency. The client device(s) 110 include one or more applications (e.g., the client application 112) that access, edit, modify, store, and/or provide, for display, digital summaries, digital documents, overall consistency scores, and the predicted document-summary consistency. For example, in some embodiments, the client application 112 include a software application installed on the client device(s) 110. In other cases, however, the client application 112 include a web browser or other application that accesses a software application hosted on the server device(s) 102.

In one or more embodiments, the factual inconsistency detection system 106 is implemented in whole, or in part, by the individual elements of the environment 100. Indeed, as shown in FIG. 1, the factual inconsistency detection system 106 is implemented with regard to the server device(s) 102 and the client device(s) 110. In particular embodiments, the factual inconsistency detection system 106 on the client device(s) 110 comprises a web application, a native application installed on the client device(s) 110 (e.g., a mobile application, a desktop application, a plug-in application, etc.), or a cloud-based application where part of the functionality is performed by the server device(s) 102.

In additional or alternative embodiments, the factual inconsistency detection system 106 on the client device(s) 110 represents and/or provides the same or similar functionality as described herein in connection with the factual inconsistency detection system 106 on the server device(s) 102. In some embodiments, the factual inconsistency detection system 106 on the server device(s) 102 supports the factual inconsistency detection system 106 on the client device(s) 110.

In some embodiments, the factual inconsistency detection system 106 includes a web hosting application that allows the client device(s) 110 to interact with content and services hosted on the server device(s) 102. To illustrate, in one or more embodiments, the client device(s) 110 accesses a web page or computing application supported by the server device(s) 102. The client device(s) 110 provides input to the server device(s) 102 (e.g., text prompts). In response, the factual inconsistency detection system 106 on the server device(s) 102 overall consistency scores and the predicted document-summary consistency. The server device(s) 102 then provides the overall consistency scores and/or the predicted document-summary consistency to the client device(s) 110.

In some embodiments, the factual inconsistency detection system 106 includes the third-party system(s) 120 and documents 122. To illustrate, in one or more embodiments, the factual inconsistency detection system 106 interacts with content and services hosted on the third-party system(s) 120. To illustrate, in one or more embodiments, the factual inconsistency detection system 106 accesses a web page or computing application supported by the third-party system(s) 120. The third-party system(s) 120 provide input to the factual inconsistency detection system 106 and documents 122 (e.g., digital summaries and digital documents). In response, the factual inconsistency detection system 106 generates/modifies digital content including generating overall consistency scores and the predicted document-summary consistency. The factual inconsistency detection system 106 then provides the digital content to the third-party system(s) 120.

In another embodiment, the factual inconsistency detection system 106 on the server device(s) 102 supports the factual inconsistency detection system 106 on the client device(s) 110. For instance, in some cases, the factual inconsistency detection system 106 on the server device(s) 102 generates or learns parameters for one or more machine learning models (e.g., a coreference resolution model, a large language model, a natural language inference model).

For example, a machine learning model includes a computer algorithm or a collection of computer algorithms that automatically improve for a particular task through iterative outputs or predictions based on use of data. To illustrate, a machine learning model utilizes one or more learning techniques to improve in accuracy and/or effectiveness. Example machine learning models include various types of neural networks, decision trees, support vector machines, linear regression models, and Bayesian networks.

Along these lines, a neural network refers to a machine learning model that is trained and/or tuned based on inputs to generate digital content such as text and images, and to determine classifications, scores, or approximate unknown functions. For example, a neural network includes a model of interconnected artificial neurons (e.g., organized in layers) that communicate and learn to approximate complex functions and generate outputs (e.g., information flow patterns) based on a plurality of inputs provided to the neural network. In some cases, a neural network refers to an algorithm (or set of algorithms) that implements deep learning techniques to model high-level abstractions in data. In some embodiments, a neural network includes various layers such as an input layer, one or more hidden layers, and an output layer that each perform tasks for processing data. For example, a neural network includes a deep neural network, a convolutional neural network, a recurrent neural network (e.g., an LSTM), a graph neural network, a transformer neural network, a diffusion neural network, a multi-scale attention network, or a large language model.

The factual inconsistency detection system 106 then, via the server device(s) 102, provides the one or more trained machine learning models to the client device(s) 110. In other words, the client device(s) 110 obtains (e.g., downloads) the one or more machine learning models (e.g., with any learned parameters) from the server device(s) 102. Once downloaded, the one or more machine learning models on the client device(s) 110 utilizes the one or more trained machine learning models to generate overall consistency scores and the predicted document-summary consistency independent from the server device(s) 102. In some implementations, the client device(s) 100 trains the one or more machine learning models.

In some embodiments, though not illustrated in FIG. 1, the environment 100 has a different arrangement of components and/or has a different number or set of components altogether. For example, in certain embodiments, the client device(s) 110 communicate directly with the server device(s) 102, bypassing the network 108. As another example, the environment 100 includes a third-party server comprising a content server and/or a data collection server.

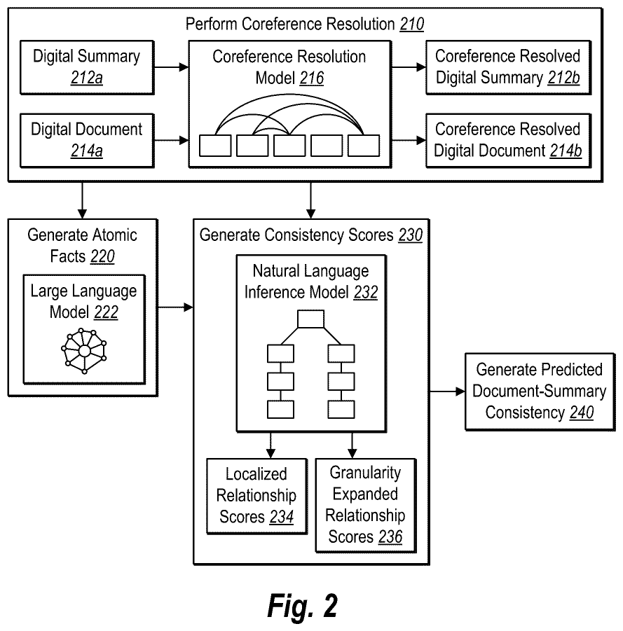

As previously mentioned, in one or more embodiments, the factual inconsistency detection system 106 generates predicted a document-summary consistency. For instance, FIG. 2 illustrates an example overview of generating a predicted document-summary consistency from a text prompt utilizing a coreference resolution model, a large language model, and a natural language inference model in accordance with one or more embodiments. Additional detail regarding the various acts of FIG. 2 is provided thereafter with reference to subsequent figures.

As shown in FIG. 2, the factual inconsistency detection system 106 performs an act 210 to perform coreference resolution. In one or more embodiments, the coreference resolution model 216 includes or refers to a model that identifies a linguistic relationship between two or more expressions in a text that refer to the same entity (e.g., coreferences). In particular, the coreference resolution model 216 links different expressions, or coreferences, within textual content that refer to the same entity. To illustrate, the coreference resolution model 216 determines types of coreferences such as pronouns (e.g., he, she, it, they), nouns (e.g., dog, athlete, it), demonstrative words (e.g., that, this, these), and aliases (e.g., inventor, teacher).

In one or more embodiments, the factual inconsistency detection system 106 utilizes the coreference resolution model 216 to generate coreference resolved documents by resolving the coreferences within the documents. In some cases, the factual inconsistency detection system 106 utilizes a coreference resolution model 216 to generate a coreference resolved digital summary 212b from a digital summary 212a. In some cases, the factual inconsistency detection system 106 utilizes the coreference resolution model 216 to generate a coreference resolved digital document 214b from a digital document 214a.

In one or more embodiments, the factual inconsistency detection system 106 performs an act 220 to generate atomic facts. In one or more embodiments, the atomic facts include or refer to granular pieces of information that represent single, discrete units of information. Furthermore, in some cases, the atomic facts represent pieces of information that convey a complete thought or statement without requiring additional context. In some embodiments, the atomic facts represent single, irreducible pieces of information. In some cases, the atomic facts represent pieces of information with a limited number of entities or tokens.

For example, the factual inconsistency detection system 106 performs the act 220 to generate atomic facts from the digital summary 212a and/or the coreference resolved digital summary 212b. In one or more embodiments, by resolving coreferences, the factual inconsistency detection system represents the set of atomic facts using explicit entity names. In some cases, the factual inconsistency detection system 106 restricts the entity count for one or more of the atomic facts to control how many distinct entities are referenced in each atomic fact (e.g., one or two). In some cases, the factual inconsistency detection system 106 restricts a token length for one or more of the atomic facts.

As shown, the factual inconsistency detection system 106 utilizes a large language model 222 to generate atomic facts from the digital summary 212a and/or the coreference resolved digital summary 212b. In some cases, the large language model 222 includes or refers to a machine learning model trained to perform computer tasks to generate textual content (e.g., atomic facts). A large language model includes a neural network (e.g., a deep neural network) that analyzes a language input to generate a predicted output. For example, a large language model includes a neural network that generates the atomic facts based on an atomic fact prompt. In some cases, the large language model utilizes a transformer architecture, which includes mechanisms such as self-attention, to capture contextual relationships in the data.

For example, a large language model can include a computer algorithm with branches, weights, or parameters that change based on training data to improve for a particular task. Thus, a large language model can utilize one or more learning techniques (e.g., supervised or unsupervised learning) to improve in accuracy and/or effectiveness.

Along these lines, the machine learning models used herein can be trained and/or fine-tuned based on a diverse text corpora to perform natural language processing tasks, such as generating atomic facts. For example, the machine learning models, consist of layers of interconnected artificial neurons organized in encoder and decoder blocks, which learn complex language patterns to generate textual content. In some cases, the machine learning models include models such as ChatGPT (Generative Pre-trained Transformer), BERT (Bidirectional Encoder Representations from Transformers), LLaMa, Zephyr, Mistral, or similar architectures that utilize self-attention mechanisms in natural language understanding and generation. In particular, in certain embodiments, the large language model 222 refers to an artificial neural network that generates the atomic facts from the coreference resolved digital summary 212b and/or the digital summary 212a. In some cases, the factual inconsistency detection system 106 utilizes 8-shot learning with the large language model 222.

As shown in FIG. 2, in one or more embodiments, the factual inconsistency detection system 106 performs an act 230 to generate consistency scores representing relationships between the digital document and the atomic facts (e.g., the digital summary). For example, the factual inconsistency detection system 106 generates localized relationship scores 234. In one or more embodiments, localized relationship scores 234 include or refer to scores that represent the relationship between a specific localized part of a digital document (e.g., a sentence) and an atomic fact. For example, the localized relationship scores 234 focus on smaller, distinct portions of the digital document to quantify the factual or logical relationship between small, specific portions of a document and an atomic fact to provide a granular evaluation of factual consistency. The factual inconsistency detection system 106 utilizes the localized relationship scores 234 for precise detection of where atomic facts are aligned, contradicted, or unrelated to sentences within the digital document.

As also shown, the factual inconsistency detection system 106 generates granularity expanded relationship scores 236. In one or more embodiments, granularity expanded relationship scores 236 include or refer to scores that represent the relationship between increasingly larger segments (relative to the localized relationship scores) of the digital document (e.g., multiple adjacent sentences) and an atomic fact. For example, the factual inconsistency detection system 106 gradually expands the scope of the evaluation from small units (e.g., individual sentences) to larger units (e.g., multiple consecutive sentences) to provide a more comprehensive understanding of the relationship between the digital document and the atomic fact. The factual inconsistency detection system 106 utilizes the granularity expanded relationship scores 236 for precise detection of where atomic facts are aligned, contradicted, or unrelated to groups of sentences within the digital document.

As described, the factual inconsistency detection system 106 utilizes a natural language inference model 232 (“NLI”) to generate relationship scores between a premise and a hypothesis. For example, the factual inconsistency detection system 106 utilizes a natural language inference model 232 to generate relationship scores between sentence(s) from the coreference resolved digital document 214b (or the digital document 214a) and an atomic fact. In some cases, the natural language inference model 232 includes or refers to a natural language inference model specifically trained to perform inference tasks, such as determining whether the atomic fact is entailed (e.g., factually consistent), contradicted (e.g., factually inaccurate), or neutral (e.g., irrelevant or unclear) in relation to the premise.

In one or more embodiments, the factual inconsistency detection system 106 utilizes a machine learning model for the natural language inference model 232 which includes a neural network such as a transformer-based model. In some cases, the natural language inference model 232 utilizes a transformer architecture trained to focus on inference tasks and capture complex relationships in language. By utilizing mechanisms such as self-attention and contextual embeddings, the natural language inference model 232 model compares textual relationships to generate relationship scores. In some implementations, the natural language inference model 232 model uses a pre-trained architecture such as BERT (Bidirectional Encoder Representations from Transformers) or T5 (Text-to-Text Transfer Transformer).

As further shown in FIG. 2, the factual inconsistency detection system 106 performs an act 240 to generate a predicted document-summary consistency. In one or more embodiments, the predicted document-summary consistency includes or refers to a metric, score, or confidence value that indicates a measure of alignment or consistency between a digital summary and a digital document. In some cases, the predicted document-summary consistency indicates the predicted accuracy of the digital summary based on how facts and details in the digital summary correspond to the digital document.

For example, the factual inconsistency detection system 106 evaluates the localized relationship scores 234 and the granularity expanded relationship scores 236 to generate a predicted document-summary consistency which represents the consistency between the digital summary 212a and the digital document 214a. In some cases, the factual inconsistency detection system 106 combines the localized relationship scores 234 and the granularity expanded relationship scores 236 to determine the predicted document-summary consistency. In some cases, the factual inconsistency detection system 106 selects a value from the localized relationship scores 234 and the granularity expanded relationship scores 236 to determine the predicted document-summary consistency.

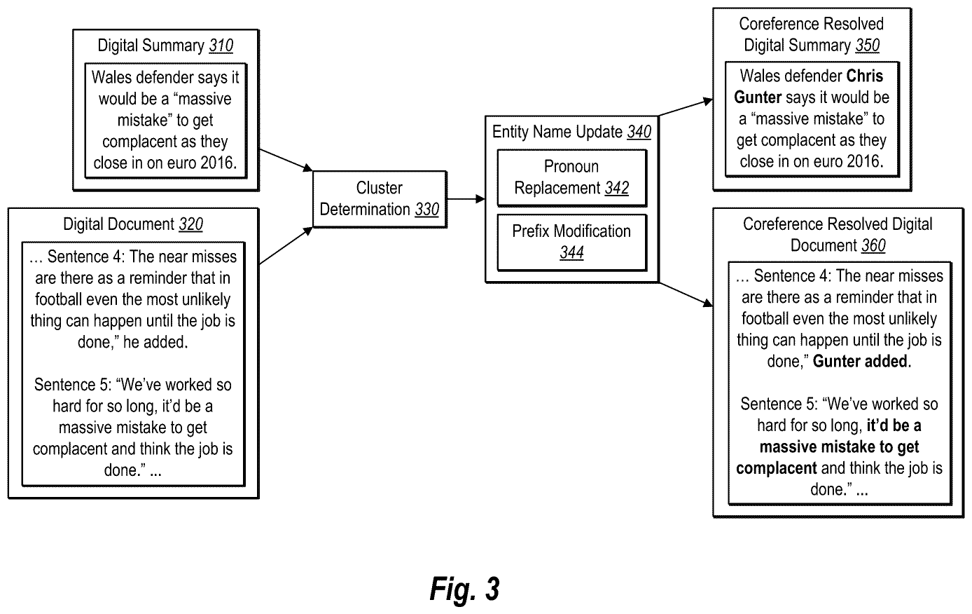

As mentioned, the factual inconsistency detection system 106 utilizes a coreference resolution model to generate a coreference resolved digital summary for the digital summary and a coreference resolved digital document for the digital summary. In this way, the factual inconsistency detection system 106 links related entities within the digital documents to provide a more accurate analysis of the digital summary and digital document. FIG. 3 illustrates an example of generating a coreference resolved digital summary and a coreference resolved digital document utilizing a coreference resolution model in accordance with one or more embodiments.

As shown in FIG. 3, the factual inconsistency detection system 106 receives a digital summary 310 and/or a digital document 320. In one or more embodiments, the digital document 320 includes or refers to content in an electronic format that contains text, data, images, or other multimedia. Relatedly, in one or more embodiments, the digital summary 310 includes or refers to a condensed version of the digital document 320. For example, the digital summary 310 contains an abridged version of the content, or portions of the content, of the digital document 320.

As shown, the factual inconsistency detection system 106 performs a cluster determination 330. In one or more embodiments, the factual inconsistency detection system 106 performs the cluster determination 330 to group related entity mentions within the digital document 320 and/or the digital summary 310 of the digital document 320. In this way, the factual inconsistency detection system 106 groups coreferences within the digital summary 310 and/or the digital document 320, including instances where different terms, pronouns, or names refer to the same entity. For example, if the digital summary refers to “Chris,” then later refers to “he” or him,” and then mentions “Mr. Gunter,” the factual inconsistency detection system 106 clusters all of these mentions together because they all refer to the same person—Chris Gunter.

In one or more embodiments, the factual inconsistency detection system 106 utilizes a sequence-to-sequence (Seq2Seg) model in conjunction with the cluster determination 330. For example, the factual inconsistency detection system 106 utilizes the Seq2Seg model to handle references that evolve throughout the digital summary 310 and/or the digital document 320 by tracking the relationships over multiple sentences. Furthermore, in some cases, the factual inconsistency detection system 106 builds the clusters step-by-step, dynamically updating clusters as new references are encountered to group entity mentions. and identify when a reference points to the same entity. In some cases, the factual inconsistency detection system 106 uses an MT5 natural language model for the cluster determination 330 to manage complex language structures and multiple entities.

In one or more embodiments, the factual inconsistency detection system 106 performs an entity name update 340 for the digital summary 310 and/or the digital document 320. For example, the factual inconsistency detection system 106 performs the entity name update 340 with a pronoun replacement 342 and/or a prefix modification 344 for clusters generated by the cluster determination 330 from the digital summary 310 and/or the digital document 320.

In one or more embodiments, the factual inconsistency detection system 106 performs the pronoun replacement 342 to replace pronouns within the clusters with the appropriate entity names. For instance, if the digital summary 310 or the digital document 320 contains a pronoun like “he” or “she,” the factual inconsistency detection system 106 replaces the pronoun with the associated entity name (e.g., “Chris Gunter”) to avoid ambiguity and to make the textual content of the clusters more explicit. Unlike some systems that use the first entity mention in a cluster as a substitute, the factual inconsistency detection system can prioritize the use of specific entity names. In this way, the factual inconsistency detection system 106 clarifies the textual content, even when multiple pronouns or references are involved.

In addition to replacing pronouns, in some cases, the factual inconsistency detection system 106 also performs the prefix modification 344 to content of the digital summary 310 and the digital document 320. In particular, the factual inconsistency detection system 106 prefixes, or suffixes, adjectives or other descriptive modifiers that refer to an entity with the entity name, followed by a comma (e.g., words or phrases used to provide additional information about an entity). For example, for the sentence “The 27-year-old joined the team in 2011,” instead of replacing “the 27-year-old” with the name “Joe Brown,” the factual inconsistency detection system 106 modifies the textual content to read “Joe Brown, the 27-year-old.” In this way, the factual inconsistency detection system 106 retains descriptive information while also reinforcing the connection between the modifier and the entity it describes.

To illustrate, the factual inconsistency detection system 106 performs an entity name update 340 that provides an improvement over conventional systems such as shown in the following table:

| Original Text | | The 27-year-old joined spurs from |
|---|---|---|
| | | Manchester city in 2011. |
| Conventional | Coreference | Emmanuel Adebayor joined spurs from |
| Systems | Resolved Text | Manchester city in 2011. |
| | Atomic Fact #1 | Emmanuel Adebayor joined spurs. |
| | Atomic Fact #2 | Emmanuel Adebayor joined spurs from |
| | | Manchester city. |
| | Atomic Fact #3 | Emmanuel Adebayor joined spurs |
| | | in 2011. |
| Factual | Coreference | Emmanuel Adebayor, the 27-year-old |
| Inconsistency | Resolved Text | joined spurs from Manchester city |
| Detection | | in 2011. |
| System | Atomic Fact #1 | Emmanuel Adebayor, the 27-year-old. |
| | Atomic Fact #2 | Emmanuel Adebayor joined spurs. |
| | Atomic Fact #3 | Emmanuel Adebayor joined spurs from |
| | | Manchester city. |
| | Atomic Fact #4 | Emmanuel Adebayor joined spurs |
| | | in 2011. |

As further shown in FIG. 3, based on the entity name update 340, the factual inconsistency detection system 106 generates a coreference resolved digital summary 350 and/or a coreference resolved digital document 360. In particular, the factual inconsistency detection system 106 generates the coreference resolved digital summary 350 and/or the coreference resolved digital document 360 where the coreferences (such as pronouns and modifiers) have been replaced/modified with appropriate entity names. The factual inconsistency detection system 106 generates the coreference resolved digital summary 350 from the digital summary 310. Furthermore, the factual inconsistency detection system 106 generates the coreference resolved digital document 360 from the digital document 320.

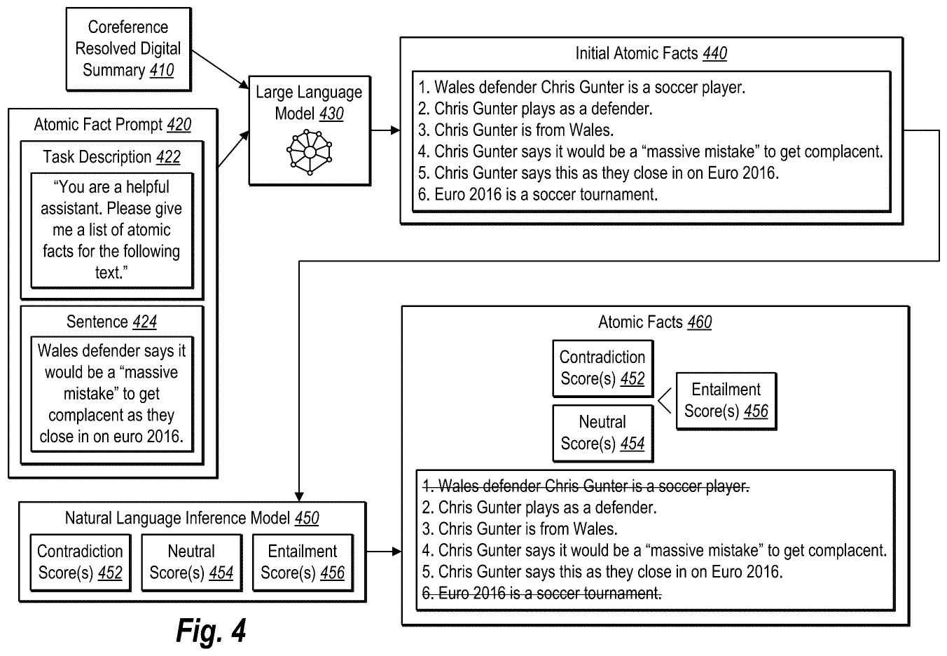

As mentioned, the factual inconsistency detection system 106 generates atomic facts for a digital summary and/or a coreference resolved digital summary 410. FIG. 4 illustrates an example of generating atomic facts utilizing a large language model in accordance with one or more embodiments.

In particular, the factual inconsistency detection system 106 utilizes a large language model 430 to generate atomic facts 460 from a digital summary of a digital document. In certain embodiments, the factual inconsistency detection system 106 utilizes the large language model 430 to generate a set of initial atomic facts 440 directly from a digital summary. In one or more embodiments, the factual inconsistency detection system 106 converts the digital summary into the coreference resolved digital summary 410 and utilizes the large language model 430 to generate the set of initial atomic facts 440. For example, the factual inconsistency detection system 106 represents the coreference resolved digital summary 410 as

$${S}^{′} = {\{ {s}_{j}^{′} \}}_{j = 1}^{N} ,$$

where

$${s}_{j}^{′}$$

represents the j^{th} sentence in S′. Furthermore, N, the total number of sentences in S′, is decomposed to the set of initial atomic facts 440

$${A}^{′} = {\{ {a}_{k}^{′} \}}_{k = 1}^{L} ,$$

where L denotes the total number of sentences in A′.

As described above, in some cases, the large language model 430 includes or refers to a machine learning model trained to generate the set of initial atomic facts 440. For example, the large language model 430 includes a neural network (e.g., a deep neural network) that analyzes the coreference resolved digital summary based on an atomic fact prompt 420 to generate a predicted output. In some cases, the factual inconsistency detection system 106 evaluates the coreference resolved digital summary 410 by decomposing each sentence in the coreference resolved digital summary 410 into individual atomic facts to generate the set of initial atomic facts 440.

As shown, the factual inconsistency detection system 106 prompts the large language model 430 with the atomic fact prompt 420. In one or more embodiments, the factual inconsistency detection system 106 incorporates a task description 422 and a sentence 424 to generate the atomic fact prompt 420. For example, the factual inconsistency detection system 106 iteratively selects the sentence 424 from the sentences of the coreference resolved digital summary 410. For example, in some cases the factual inconsistency detection system 106 generates the atomic fact prompt 420 from a task description 422 of “You are a helpful assistant. Please give me a list of atomic facts for the following text” and a sentence from the coreference resolved digital summary. In some cases, the factual inconsistency detection system 106 utilizes the sentence 424 such as: “Wales defender Chris Gunter says it would be a ‘massive mistake’ to get complacent as they close in on euro 2016.” In some cases, the factual inconsistency detection system 106 generates the atomic fact prompt 420 of “You are a helpful assistant. Please give me a list of atomic facts for the following text: Wales defender Chris Gunter says it would be a ‘massive mistake’ to get complacent as they close in on euro 2016.”

In some cases, the factual inconsistency detection system 106 generates the atomic fact prompt 420 such as the following:

```
You are a helpful assistant. Please give me a list of atomic for the following texts:
  Lisa Courtney, of Hertfordshire, has spent most of her life collecting memorabilia.
  Rudd has plead guilty to threatening to kill and possession of drugs in a court.
  Lee made his acting debut in the film The Moon is the Sun's Dream (1992) and
continued to appear in small and supporting roles throughout the 1990s.
  Michael Collins (born October 31, 1930) is a retired American astronaut and test
pilot who was the Command Module Pilot for the Apollo 11 mission in 1969.
```

Furthermore, in some cases, the factual inconsistency detection system 106 provides additional requirements to the large language model 430 within the atomic fact prompt 420. For example, the factual inconsistency detection system 106 restricts the entity count for one or more of the set of initial atomic facts 440 to control how many distinct entities are referenced in each atomic fact (e.g., one or two). In some cases, the factual inconsistency detection system 106 restricts a token length for one or more of the set of initial atomic facts 440 (e.g., 80, 90, 100). In one or more embodiments, by resolving coreferences, the factual inconsistency detection system 106 represents the set of initial atomic facts 440 using explicit entity names.

As illustrated in FIG. 4, the factual inconsistency detection system 106 generates the set of initial atomic facts 440 of “1. Wales defender Chris Gunter is a soccer player,” “2. Chris Gunter plays as a defender,” “3. Chris Gunter is from Wales,” “4. Chris Gunter says it would be a ‘massive mistake’ to get complacent,” “5. Chris Gunter says this as they close in on Euro 2016,” and “6. Euro 2016 is a soccer tournament” from the atomic fact prompt 420. As another example, the factual inconsistency detection system 106 generates the set of initial atomic facts 440 of “1. Michael Collins was born on Oct. 31, 1930,” “2. Michael Collins is retired,” “3. Michael Collins is an American,” “4. Michael Collins was an astronaut,” “5. Michael Collins was a test pilot,” “6. Michael Collins was the Command Module Pilot for the Apollo 11 mission in 1969” based on an atomic fact prompt 420 generated for the sentence 424 of “Michael Collins (born Oct. 31, 1930) is a retired American astronaut and test pilot who was the Command Module Pilot for the Apollo 11 mission in 1969.”

Furthermore, in one or more embodiments, the factual inconsistency detection system 106 utilizes a natural language inference model 450 to filter the set of initial atomic facts 440 to generate the atomic facts 460. For example, the factual inconsistency detection system 106 filters the set of the initial atomic facts 440 to remove incorrect or irrelevant atomic facts. For example, in some cases, the large language model 430 hallucinates and produces the set of initial atomic facts 440 which include knowledge embedded within the large language model 430. To illustrate, when the large language model 430 decomposes the sentence 424 “Wales defender Chris Gunter says it would be a ‘massive mistake’ to get complacent as they close in on euro 2016,” the large language model 430 generates the decomposed atomic fact “Euro 2016 is a soccer tournament.” In this case, the factual inconsistency detection system 106 determines the decomposed atomic fact “Euro 2016 is a soccer tournament” to be irrelevant to the coreference resolved digital summary 410 and filters “Euro 2016 is a soccer tournament” to generate the atomic facts 460. In this way, the factual inconsistency detection system 106 filters the set of initial atomic facts 440 that do not align with the coreference resolved digital summary 410.

To filter the atomic facts, in one or more embodiments, the factual inconsistency detection system 106 utilizes the natural language inference model 450 to generate summary relationship scores. In one or more embodiments, summary relationship scores include or refer to probabilistic scores generated by the natural language inference model 450 using a probabilistic distribution to evaluate the consistency between the set of initial atomic facts 440 and the coreference resolved digital summary 410. For example, summary relationship scores include a contradiction score(s) 452, a neutral score(s) 454, and an entailment score(s) 456 that evaluate the relationship(s) between the set of initial atomic facts 440 and the coreference resolved digital summary 410. The summary relationship scores quantify how well the information in the summary aligns with or reflects the content, facts, and meaning of the coreference resolved digital summary 410. For example, the contradiction score(s) 452 quantifies if the set of initial atomic facts 440 misrepresents or conflicts with the coreference resolved digital summary 410, the neutral score(s) 454 quantifies if the set of initial atomic facts 440 is neither supported nor contradicted by the coreference resolved digital summary 410, and the entailment score(s) 456 quantifies if the set of initial atomic facts 440 is supported or entailed by the coreference resolved digital summary 410.

For example, the natural language inference model 450 assesses whether the set of initial atomic facts 440 aligns with the information presented in coreference resolved digital summary 410 based on classifying the relationship between a premise and a hypothesis. For example, the factual inconsistency detection system 106 treats the coreference resolved digital summary 410 as the premise and the set of initial atomic facts 440 as the hypothesis. In turn, the natural language inference model 450 tests whether each atomic fact of the set of initial atomic facts 440 logically follows from the information provided in the coreference resolved digital summary 410. In turn, the natural language inference model 450 generates the summary relationship scores including the contradiction score(s) 452, the neutral score(s) 454, and the entailment score(s) 456. In some cases, the values of the summary relationship scores represent the confidence of the natural language inference model 450 of the factual consistency between the premise and the hypothesis.

In this way, the factual inconsistency detection system 106 aligns the atomic facts 460 with the content of the coreference resolved digital summary 410. For example, based on the summary relationship scores, the factual inconsistency detection system 106 filters the set of initial atomic facts 440 to determine the atomic facts 460. In some cases, the factual inconsistency detection system 106 determines the atomic facts 460 as the set of initial atomic facts 440 where the entailment score(s) 456 is greater than the contradiction score(s) 452 and the neutral score(s) 454. In some cases, the factual inconsistency detection system 106 utilizes an algorithm such as the following to determine the summary relationship scores and refine the atomic facts 460:

Algorithm 1 Filtering Atomic Facts

$Input \text{:} An NLI model ; coreference resolved digital summary {S}^{′} = {\{ {S}_{j}^{′} \}}_{j = 1}^{N} ;$
$decomposed atomic facts {A}^{′} = {\{ {a}_{k}^{′} \}}_{k = 1}^{L} .$
Initialize: Set A_{filtered} = φ
1: for k = 1, 2, ... , L do
2: for j = 1, 2, ... , N do
3: (e_{j,k}, C_{j,k}, n_{j,k}) ← [symbol] (s′ⱼ, a′ₖ)
4: if max(e_{j,k}, c_{j,k}, n_{j,k}) is e_{j,k} then
5: Append a′ₖ to A_{filtered}.
6: end if
7: end for
8: end for
Output: A set of the atomic facts 460 (e.g., A_{filtered}).

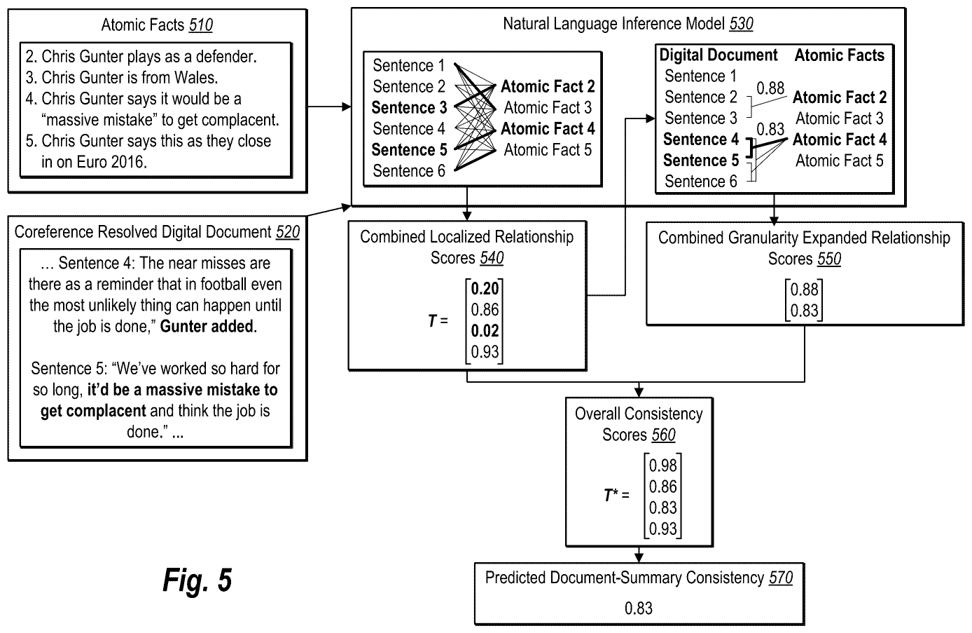

As mentioned, the factual inconsistency detection system 106 determines a predicted document-summary consistency between the digital summary and the digital document. In some cases, to determine the predicted document-summary consistency, the factual inconsistency detection system 106 utilizes a natural language inference model to evaluate the relationships between sentences of a coreference resolved digital document and atomic facts. FIG. 5 illustrates an example of utilizing a natural language inference model to generate a predicted document-summary consistency in accordance with one or more embodiments.

As shown in FIG. 5, the factual inconsistency detection system 106 utilizes a natural language inference model 530. For example, factual inconsistency detection system 106 utilizes the natural language inference model 530 to assess whether the atomic facts 510 align with the information presented in coreference resolved digital document 520 based on classifying the relationship between a premise and a hypothesis using document relationship scores (e.g., entailment scores, contradiction scores, and neutral scores). In one or more embodiments, the document relationship scores include or refer to probabilistic scores generated by the natural language inference model 530 using a probabilistic distribution to evaluate the consistency between the atomic facts 510 and the coreference resolved digital summary 520. In one or more embodiments, the factual inconsistency detection system 106 utilizes the natural language inference model 450 as the natural language inference model 530. In one or more embodiments, the factual inconsistency detection system 106 does not utilize the natural language inference model 450 as the natural language inference model 530.

In one or more embodiments, the factual inconsistency detection system 106 determines combined localized relationship scores 540 for the atomic facts 510. In one or more embodiments, the combined localized relationship scores 540 includes or refers to a compilation of prediction values (e.g., individual combined localized relationship scores) of the factual consistency for each of the atomic facts with the coreference resolved digital document 520. For example, the factual inconsistency detection system 106 determines combined localized relationship scores 540 for the atomic facts 510 by compiling combined localized relationship scores that the natural language inference model 530 generates for individual atomic facts of the atomic facts 510. In some cases, the factual inconsistency detection system 106 selects a premise from the individual sentence(s) of the coreference resolved digital document 520 and a hypothesis as an atomic fact of the atomic facts 510 for the natural language inference model 450 to generate the combined localized relationship scores 540.

To illustrate, the factual inconsistency detection system 106 decomposes the coreference resolved digital document 520 D′ into M sentences and the atomic facts 510 into L atomic facts, to formulate

$${D}^{′} = {\{ {d}_{i}^{′} \}}_{j = 1}^{M} and A = {\{ {a}_{k} \}}_{k = 1}^{L} ,$$

respectively. In turn, the factual inconsistency detection system 106 provides (dᵢ, aₖ) as input for the natural language inference model 530, utilizing the atomic fact aₖ as the hypothesis and the sentence dᵢ of the coreference resolved digital document 520 as the premise to determine document relationship scores for the atomic fact ax. In some cases, the factual inconsistency detection system 106 provides (dᵢ, aₖ) as an input for the natural language inference model 530, for the sentences M where 1≤j≤M from the coreference resolved digital document 520 D′ to obtain a set of document relationship scores (e_{i,k}, c_{i,k}, n_{i,k}) for the atomic fact aₖ. Based on the set of document relationship scores, the factual inconsistency detection system 106 generates localized relationship scores for the atomic facts 510 representing the entailment scores E={e_{i,k}} for the atomic fact aₖ.

Similarly, the factual inconsistency detection system 106 provides (dᵢ, aₖ) as an input for the natural language inference model 530, for the atomic facts 510 where 1≤k≤L to compare the atomic facts 510 with the sentences M in D′. In this way, the factual inconsistency detection system 106 iteratively generates document relationship scores for the atomic facts 510

$$( e . g . , {\{ {a}_{k} \}}_{k = 1}^{L} ) .$$

Furthermore, the factual inconsistency detection system 106 determines combined localized relationship scores 540 for the atomic facts 510. For example, the factual inconsistency detection system 106 determines a combined localized relationship score for the atomic fact aₖ from the localized relationship scores for the atomic fact aₖ. In some cases, the factual inconsistency detection system 106 determines the combined localized relationship score for the atomic fact ax by comparing the localized relationship scores for the atomic fact aₖ. In some cases, the factual inconsistency detection system 106 determines the combined localized relationship score for the atomic fact ax as the maximum of the localized relationship scores for the atomic fact aₖ. In some cases, the factual inconsistency detection system 106 determines the combined localized relationship score for the atomic fact ax as the maximum entailment score from E={e_{i,k}}. In some cases, the factual inconsistency detection system 106 determines the combined localized relationship score for aₖ, where 1≤i≤M and 1≤k≤L, as:

$${t}_{k} = {max}_{1 \leq i \leq M} {e}_{i , k}$$

In one or more embodiments, the factual inconsistency detection system 106 determines the combined localized relationship scores 540 based on a combination of the combined localized relationship scores for the atomic facts 510. For example, the factual inconsistency detection system 106 determines the combined localized relationship scores 540 as a vector T which includes the combined localized relationship score for the atomic facts 510

$$( e . g . , {\{ {a}_{k} \}}_{k = 1}^{L} ) .$$

To illustrate, for

$${\{ {a}_{k} \}}_{k = 1}^{L} ,$$

the factual inconsistency detection system 106 determines the combined localized relationship scores 540 is computed as a vector T, where 1≤k≤L, such that:

$$T = \{ {t}_{1} , … , {t}_{L} \}$$

In one or more embodiments, the factual inconsistency detection system 106 increases the granularity when analyzing the factual consistency between the atomic facts 510 and the coreference resolved digital document 520. In some cases, based on determining a subset of the combined localized relationship scores 540 fails to satisfy a relationship threshold for the coreference resolved digital document 520, the factual inconsistency detection system 106 generates combined granularity expanded relationship scores 550 for the atomic facts. For example, the factual inconsistency detection system 106 identifies an atomic fact dx where the combined localized relationship score is associated with an entailment score that is less than the contradiction score or the neutral score. In other words, the factual inconsistency detection system 106 identifies a subset of the atomic facts 510 (e.g., one or more atomic fact aₖ) where the where the maximum document relationship score is not the entailment score (e.g., max(eₖ, cₖ, nₖ) is either cₖ or nₖ). In one or more embodiments, the factual inconsistency detection system 106 adaptively increases the granularity for a subset of the atomic facts 510 where the entailment score significantly decreases.

To illustrate, for the subset of the atomic facts 510, the factual inconsistency detection system 106 increases the granularity of the premise for the natural language inference model 530 to generate granularity expanded relationship scores for the atomic facts 510. In particular, the factual inconsistency detection system 106 increases the granularity of the premise (e.g., a number of sentences from the coreference resolved digital document 520) for the hypothesis (e.g., the subset of the atomic facts 510). In some cases, the factual inconsistency detection system 106 incrementally increases the granularity starting from the sentence dᵢ of the coreference resolved digital document 520 that contributed to each identified localized relationship score. In certain embodiments, the factual inconsistency detection system 106 adaptively increases the granularity by comparing the atomic facts 510 to increasing sizes of adjacent sentence combinations (e.g., 1, 2, 3, 4, 5). In some cases, the factual inconsistency detection system 106 limits the granularity to a maximum of three sentences (e.g., dᵢ₋₁+dᵢ, dᵢ+dᵢ₊₁, dᵢ₋₂+dᵢ₋₁+dᵢ, dᵢ+dᵢ₊₁+dᵢ₊₂, dᵢ₋₁+dᵢ+dᵢ₊₁). Based on incrementally increasing the granularity of the premise as described the factual inconsistency detection system 106 utilizes the natural language inference model 530 to generate combined granularity expanded relationship scores 550.

To illustrate, the factual inconsistency detection system 106 decomposes the coreference resolved digital document 520 D′ into M_{idx} sentence groupings and the atomic facts 510 into L atomic facts, to formulate

$${D}_{idx}^{′} = {\{ {d}_{i}^{′} \}}_{j = 1}^{{M}_{idx}} and A = {\{ {a}_{k} \}}_{k = 1}^{L} ,$$

respectively. In turn, the factual inconsistency detection system 106 provides (d_{idx}, aₖ) as input for the natural language inference model 530, utilizing the atomic fact aₖ as the hypothesis and the sentence grouping d_{idx} of the coreference resolved digital document 520 as the premise to determine document relationship scores for the atomic fact aₖ. Based on the set of document relationship scores, the factual inconsistency detection system 106 generates granularity expanded relationship scores for the atomic facts 510 representing the entailment scores E={e_{i,k}} for the atomic fact aₖ.

In one or more embodiments, the factual inconsistency detection system 106 generates combined granularity expanded relationship scores 550 (e.g., E_{expanded}) as a set of the granularity expand relationship scores as shown in Algorithm 2:

Algorithm 2 Scoring with Document Granularity Expansion

```
$Input \text{:} An NLI model ; coreference resolved digital document {D}^{′} = {\{ {d}_{i}^{′} \}}_{i = 1}^{M} ;$
$decomposed atomic facts {A}^{′} = {\{ {a}_{k}^{′} \}}_{k = 1}^{L} .$
Initialize: T* = φ; Max granularity size gran = 3.
  1: Define C(D, g) = list of subsets of D with size of g.
  2: Define F(C(D, g)) which returns whether C(D, g) is a consecutive list.
  3: Define D(C(D, g)) = list of document sentences in index list in C(D, g).
  4: for k = 1, 2, ... , L do
  5:  set E = φ
  6:  for i = 1, 2, ... , M do
  7:  (e_{i,k}, c_{i,k}, n_{i,k}) ← [symbol] (d′ᵢ, a′ₖ)
  8:  Append e_{i,k} to E.
  9:  end for
10:  m_{idx} = E. index(max(E))
11:  if max(e_{i,k}, c_{i,k}, n_{i,k}) is not e_{i,k} then
12:  set D_{idx} = [0, ... , M − 1]
13:  set Dexpanded = φ
14:  for g = 1,2, ... , gran + 1 do
15:  if m_{idx} in C(D_{idx}, g) and f (C(D_{idx}, g)) then
16:  Extend C(D_{idx}, g) to D_{expanded}.
17:  end if
18:  end for
19:  set E_{expanded} = φ
20:  for d_{expanded} ∈ D(D_{expanded}) do
21:  (e, c, n) ← [symbol] (d_{expanded}, a′ₖ )
22:  Append e to E_{expanded}.
23:  end for
24:  Append max (E_{expanded}) to T*.
25:  else
26:  Append e_{i,k} to T*.
27:  end if
28: end for
Output: Vector T* with overall consistency scores for the atomic facts.
```

As also shown in Algorithm 2, in some cases, the factual inconsistency detection system 106 generates overall consistency scores 560 (e.g., vector T*). In one or more embodiments, the overall consistency scores 560 include or refer to scores that reflect the factual consistency between the atomic facts 510 and the coreference resolved digital document 520 based on a combination of the combined localized relationship scores 540 and the combined granularity expanded relationship scores 550. As shown in FIG. 5, to determine the overall consistency scores 560, the factual inconsistency detection system 106 transforms the vector T into T* by replacing one or more of the combined localized relationship scores 540 with a combined granularity expanded relationship score. For example, the factual inconsistency detection system 106 replaces the combined localized relationship scores 540 for an atomic fact aₖ of the atomic facts 510 based on a comparison between the combined localized relationship score for the atomic fact aₖ and the combined granularity expanded relationship score for the atomic fact aₖ. In some cases, the factual inconsistency detection system 106 replaces the combined localized relationship scores 540 for an atomic fact aₖ of the atomic facts 510 based on the maximum of the combined localized relationship score for the atomic fact aₖ and the combined granularity expanded relationship score for the atomic fact aₖ. Notably, the overall consistency scores 560 represent how strongly the coreference resolved digital document supports the atomic facts 510 based on both individual sentences and expanded groups of sentences:

As further shown in FIG. 5, the factual inconsistency detection system 106 generates the predicted document-summary consistency 570. The factual inconsistency detection system 106 generates the predicted document-summary consistency 570 to represent the factual consistency between the atomic facts 510 and the coreference resolved digital document 520 (or the digital summary and the digital document). In certain embodiments, the factual inconsistency detection system 106 generates the predicted document-summary consistency 570 as a percentage, a numerical value, a metric, or a confidence level. In some cases, the factual inconsistency detection system 106 utilizes the minimum score from the overall consistency scores 560 as the predicted document-summary consistency 570.

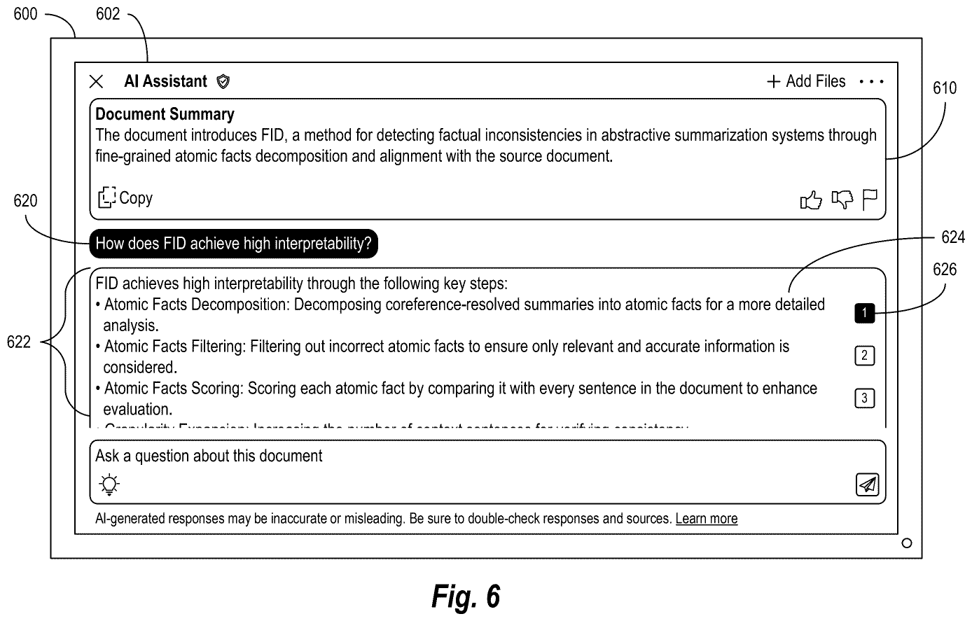

As mentioned previously, in one or more implementations, the factual inconsistency detection system 106 provides advantages in accuracy and flexibility over existing fact verification models. FIG. 6 illustrates an example of utilizing a graphical user interface to refine content utilizing the factual inconsistency detection system 106 in accordance with one or more embodiments.

As shown, the factual inconsistency detection system 106 provides a graphical user interface 602 for display on a client device 600. In particular, the factual inconsistency detection system 106 provides the graphical user interface 602 for displaying digital content including digital summaries. In some cases, the factual inconsistency detection system 106 interfaces with a client application to provide the digital summary 610 to the client device. In some cases, the factual inconsistency detection system 106 provides granular feedback such as the predicted document-summary consistency, the overall consistency scores, or digital content for a digital summary 610 to the client device 600.

For example, the factual inconsistency detection system 106 displays the digital summary 610 for a digital document. The factual inconsistency detection system 106 displays the digital summary 610 on the client device 600 based on the values of the predicted document-summary consistency and/or the overall consistency scores between the digital summary 610 and the digital document. For example, in certain cases the factual inconsistency detection system 106 modifies the digital summary 610 before displaying the digital summary 610. In some cases, the factual inconsistency detection system 106 regenerates the digital summary 610 before display (e.g., to improve a predicted document-summary consistency for the digital summary 610). In some cases, the factual inconsistency detection system 106 filters portions that are not consistent with the digital document from the digital summary 610 before displaying the digital summary 610 on the client device 600 (e.g., filters portions based on the overall consistency scores). In some cases, the client device 600 displays a consistency confidence indication for the digital summary 610 based on the predicted document-summary consistency (or overall consistency scores).

As also shown in FIG. 6, the factual inconsistency detection system 106 improves the interpretability of digital content 622 through a granular analysis. For example, based on the question 620, the factual inconsistency detection system 106 displays the digital content 622 which includes digital summaries (e.g., summarized answers) generated from the content of a digital document. As shown, the factual inconsistency detection system 106 displays a link 626 to associated portions within the digital document that are factually consistent with the digital summary 624. In some cases, the factual inconsistency detection system 106 provides consistency confidence score(s) for the digital summary 624.

To illustrate, the factual inconsistency detection system 106 evaluates the digital summary 624 as described in relation to FIGS. 2-6. Furthermore, the factual inconsistency detection system 106 determines a sentence or a group of sentences within the digital document that are most factually consistent with atomic facts extracted from the digital summary 624. The factual inconsistency detection system 106 assigns overall consistency scores between atomic facts and the digital document. Moreover, the factual inconsistency detection system 106 determines a predicted document-summary consistency between the digital summary 624 and the digital document. In turn, the factual inconsistency detection system 106 provides a link 626 to the sentence or the group of sentences. In some cases, the factual inconsistency detection system 106 provides the overall consistency scores and/or the predicted document-summary consistency for the digital summary 624 for display on the client device 600.

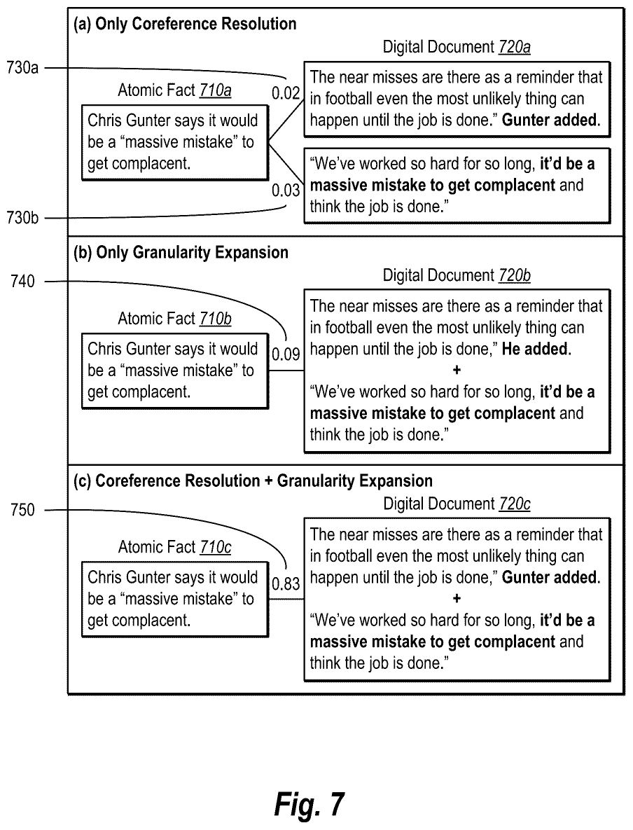

As described above, the factual inconsistency detection system 106 utilizes both coreference resolution and granularity expansion to generate the predicted document-summary consistency. FIG. 7 illustrates a comparison of the factual inconsistency detection system using various configurations in accordance with one or more embodiments. In particular, as shown in FIG. 7, the factual inconsistency detection system 106 utilizes combinations of coreference resolution and granularity expansion to evaluate the factual consistency between an atomic fact and a digital document.

As shown, based on coreference resolution without granularity expansion, the factual inconsistency detection system 106 generates an entailment score 730a and an entailment score 730b that reflect the consistency between the atomic fact 710a and the digital document 720a. However, without utilizing coreference resolution, the factual inconsistency detection system 106 generates the entailment score 730a and the entailment score 730b which may not accurately reflect the consistency between the atomic fact 710a and the digital document 720a. In particular, as shown in FIG. 7, because segmenting the dialogue from the digital document into discrete sentences led to a loss of contextual clarity, the factual inconsistency detection system 106 generates the entailment score 730a and the entailment score 730b which do not accurately reflect the consistency between the atomic fact 710a and the digital document 720a.

Furthermore, based granularity expansion without coreference resolution, the factual inconsistency detection system 106 generates an entailment score 740 that reflects the consistency between the atomic fact 710b and the digital document 720b. Based on granularity expansion without coreference resolution, the factual inconsistency detection system 106 adaptively expands the document granularity without resolving the coreferences. In this way, the factual inconsistency detection system 106 accounts for the fact that a single sentence within a document summary may incorporate content from multiple sentences within a digital document synthesizes sentences to improve document interpretation and generate the entailment score 740. However, as shown, without coreference resolution, the entailment score 740 inaccurately reflects the consistency between the atomic fact 710b and the digital document 720b. This is demonstrated by comparing the difference between the entailment score 740 and entailment score 750, in which the difference between digital document 720b and digital document 720c is merely the resolution of pronouns. With this modification, the factual inconsistency detection system 106 recognizes the reference to “he” pertains to “Chris Gunter.”

As shown in FIG. 7, when based on both coreference resolution and granularity expansion, the factual inconsistency detection system 106 generates an entailment score 750 that accurately reflects the consistency between the atomic fact 710c and the digital document 720c. For example, by combining coreference resolution and granularity expansion the factual inconsistency detection system 106 generates the entailment score 750 to reflect the consistency between the atomic fact 710c and the digital document 720c. As shown in the table below, the factual inconsistency detection system 106 consistently provides better results when both coreference resolution and granularity expansion are utilized for both the digital summary and the digital document.

| Digital | Digital | | | |
|---|---|---|---|---|
| Summary | Document | CNN | XSUM | AVG |
| Original | Original | 63.2 ± 2.3 | 66.4 ± 1.8 | 64.8 |
| | Coref. Resolved | 65.7 ± 3.4 | 67.8 ± 2.0 | 66.7(+1.95) |
| Coref. | Original | 66.2 ± 3.4 | 66.6 ± 1.9 | 66.4 |
| Resolved | Coref. Resolved | 72.2 ± 2.7 | 66.3 ± 1.9 | 69.2(+2.85) |

Furthermore, by using adaptive granular expansion for atomic facts where the entailment scores significantly decrease, the factual inconsistency detection system 106 provides a consistent improvement in accuracy. As shown in the table below, the factual inconsistency detection system 106 shows consistent improvement when using a granularity expansion of three or four sentences.

| Digital Document | AGGREFACT- | AGGREFACT- | | |
|---|---|---|---|---|
| Max Granularity | CNNFTSOTA | XSUM-FTSOTA | AVG | s/it |
| One Sent. | 72.2 ± 2.8 | 66.3 ± 1.9 | 69.25 | 2.49 |
| Two Sent. | 71.0 ± 3.2 | 69.3 ± 2.0 | 70.15 | 2.53 |
| Three Sent. | 72.6 ± 3.0 | 69.3 ± 1.9 | 7.095 | 2.64 |
| Four Sent. | 72.1 ± 3.1 | 70.0 ± 1.8 | 71.05 | 2.80 |

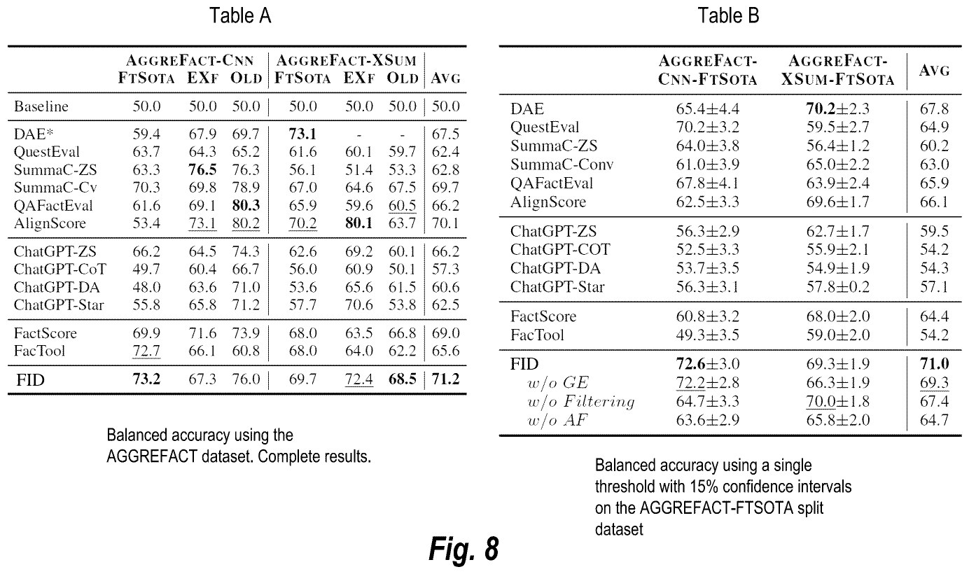

As mentioned, the factual inconsistency detection system 106 improves the accuracy of consistency evaluation for digital summaries when compared to existing systems. FIG. 8 illustrates the results of a comparison of the factual inconsistency detection system with existing systems in accordance with one or more embodiments.

As shown in FIG. 8, the factual inconsistency detection system 106 provides consistent and accurate results when compared to existing systems. For example, in Table A, the evaluation of balanced accuracy using the AGGREFACT dataset show that, on average, the factual inconsistency detection system 106 (“FID”) outperforms existing systems. In addition, as shown by Table B for an evaluation of balanced accuracy using a single threshold with 95% confidence intervals on the AGGREFACT-FISOTA split dataset, the factual inconsistency detection system 106 outperforms existing systems. As also shown by Table B, the factual inconsistency detection system 106 without granularity expansion (“w/o GE”) and without filtering (“w/o Filtering”) also outperform existing systems, while the factual inconsistency detection system 106 without atomic facts (“w/o AF”) performs competitively.

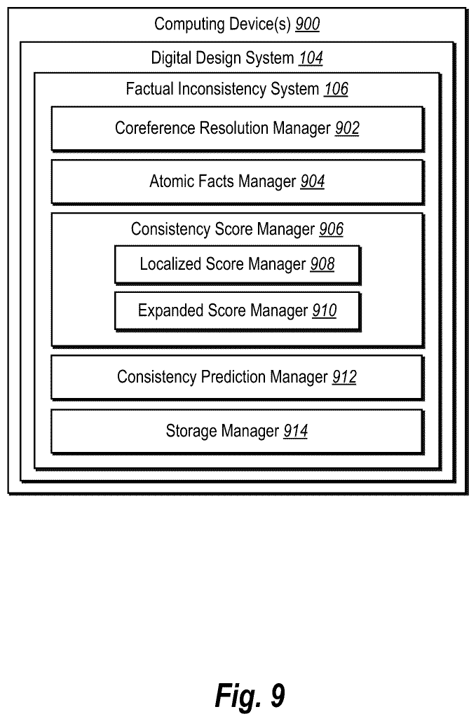

Turning now to FIG. 9, additional detail will now be provided regarding various components and capabilities of the factual inconsistency detection system 106. In particular, FIG. 9 illustrates the factual inconsistency detection system 106 implemented by the computing device 900 (e.g., the server device(s) 102 and/or one of the client device(s) 110 discussed above with reference to FIG. 1). Additionally, the factual inconsistency detection system 106 is also part of the digital content management system 104. As shown in FIG. 9, the factual inconsistency detection system 106 includes, but is not limited to, a coreference resolution manager 902, an atomic facts manager 904, a consistency score manager 906, a consistency prediction manager 912, and a data storage manager 914.

As just mentioned, and as illustrated in FIG. 9, the factual inconsistency detection system 106 includes the coreference resolution manager 902. In one or more embodiments, the coreference resolution manager 902 manages a coreference resolution model to generate coreference resolved digital documents. In one or more embodiments, the coreference resolution manager 902 utilizes a coreference resolution model to generate a coreference resolved digital summary by performing coreference resolution on a digital summary. In certain embodiments, the coreference resolution manager 902 utilizes the coreference resolution model to generate a coreference resolved digital document by performing coreference resolution on a digital document. In one or more embodiments, the coreference resolution manager 902 replaces pronouns with entity names and prefixes, or suffixes, adjectives or other descriptive modifiers that refer to an entity with the entity names.

As further shown in FIG. 9, the factual inconsistency detection system 106 includes the atomic facts manager 904. In one or more embodiments, the atomic facts manager 904 generates atomic facts from the coreference resolved digital summary (and/or the digital summary). In particular, the atomic facts manager 904 utilizes a large language model to generate the atomic facts. In some cases, the atomic facts manager 904 utilizes a natural language inference model to filter the atomic facts. In one or more embodiments, the atomic facts manager 904 utilizes the natural language inference model to generate summary relationship scores (e.g., probabilistic scores) including a contradiction score, a neutral score, and an entailment score. Based on the summary relationship scores, the atomic facts manager 904 filters the atomic facts to remove incorrect or irrelevant atomic facts.

As also shown in FIG. 9, the factual inconsistency detection system 106 utilizes the consistency score manager 906 to perform a localized sentence-level analysis and an expanded-sentence analysis utilizing the atomic facts. For example, the consistency score manager 906 utilizes a localized score manager 908 to perform a localized sentence-level analysis utilizing the atomic facts. In turn, the consistency score manager 906 utilizes an expanded score manager 910 to perform an expanded-sentence analysis utilizing a subset of the atomic facts.

In some cases, the localized score manager 908 utilizes a natural language inference model to compare atomic facts to individual sentences of the coreference resolved digital document. In one or more embodiments, the localized score manager 908 generates document relationship scores (e.g., probabilistic scores) including contradiction scores, neutral scores, and entailment scores. Based on the document relationship scores, the localized score manager 908 determines localized relationship scores which represent whether each atomic fact logically follows based on the individual sentences in the coreference resolved digital document.

In some cases, the expanded score manager 910 further refines the analysis by adaptively increasing the granularity of the premise for the natural language inference model. In some cases, the expanded score manager 910 determines granularity expanded relationship scores for atomic facts where the entailment score is less than the contradiction score or the neutral score. In one or more embodiments, similar to the localized score manager 908 the expanded score manager 910 generates document relationship scores (e.g., probabilistic scores) including contradiction scores, neutral scores, and entailment scores. In this way, the expanded score manager 910 determines granularity expanded relationship scores by comparing the atomic facts to multiple sentences from the coreference resolved digital document.

As shown in FIG. 9, the factual inconsistency detection system 106 utilizes the consistency prediction manager 912. The consistency prediction manager 912 determines a predicted document-summary consistency for the comparison of the digital summary with the digital document based on the localized relationship scores and the granularity expanded relationship scores. Based on a text prompt, the consistency prediction manager 912 combines the localized relationship scores with the granularity expanded relationship scores to generate overall consistency scores for the atomic facts. In particular, the consistency prediction manager 912 generates the predicted document-summary consistency based on comparing the values of the overall consistency scores. In certain embodiments, the consistency prediction manager 912 generates the predicted document-summary consistency to predict a consistency between the digital summary and the digital document.

Additionally, as shown, the factual inconsistency detection system 106 includes the data storage manager 914. In particular, the data storage manager 914 (implemented by one or more memory devices) stores the digital summaries and digital documents, including the coreference resolved digital summaries and the coreference resolved digital documents. The data storage manager 914 facilitates the use of the digital documents by the factual inconsistency detection system 106.

Each of the components 902-914 of the factual inconsistency detection system 106 includes software, hardware, or both. For example, the components 902-914 include one or more instructions stored on a computer-readable storage medium and executable by processors of one or more computing devices, such as a client device or server device. When executed by the one or more processors, the computer-executable instructions of the factual inconsistency detection system 106 causes the computing device(s) to perform the methods described herein. Alternatively, the components 902-914 include hardware, such as a special-purpose processing device to perform a certain function or group of functions. Alternatively, the components 902-914 of the factual inconsistency detection system 106 include a combination of computer-executable instructions and hardware.

Furthermore, the components 902-914 of the factual inconsistency detection system 106 are implemented as one or more operating systems, as one or more stand-alone applications, as one or more modules of an application, as one or more plug-ins, as one or more library functions or functions called by other applications, and/or as a cloud-computing model. Thus, in some embodiments, the components 902-914 of the factual inconsistency detection system 106 are implemented as a stand-alone application, such as a desktop or mobile application. Furthermore, in some embodiments, the components 902-914 of the factual inconsistency detection system 106 are implemented as one or more web-based applications hosted on a remote server. Alternatively, or additionally, the components 902-914 of the factual inconsistency detection system 106 are implemented in a suite of mobile device applications or “apps.” For example, in one or more embodiments, the factual inconsistency detection system 106 comprises or operates in connection with digital software applications such as: ADOBE EXPRESS, ADOBE PHOTOSHOP, ADOBE PHOTOSHOP ELEMENTS, ADOBE ILLUSTRATOR, ADOBE INCOPY, ADOBE INDESIGN, ADOBE DESIGNER, ADOBE ACROBAT, and ADOBE PREMIERE. The foregoing are either registered trademarks or trademarks of Adobe Inc. in the United States and/or other countries.

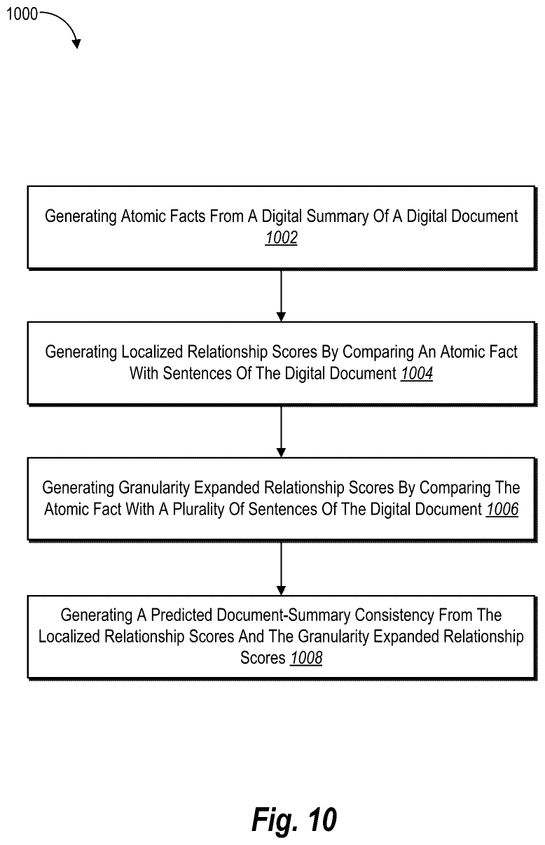

FIGS. 1-9, the corresponding text, and the examples provide a number of different methods, systems, devices, and non-transitory computer-readable media of the factual inconsistency detection system 106. In addition to the foregoing, one or more embodiments are also described in terms of flowcharts comprising acts for accomplishing a particular result, as shown in FIG. 10. In some embodiments, the acts shown in FIG. 10 are performed in connection with more or fewer acts. Further, the acts may be performed in differing orders. Additionally, in various embodiments, the acts described herein are repeated or performed in parallel with one another or parallel with different instances of the same or similar acts. A non-transitory computer-readable medium includes instructions that, when executed by one or more processors, cause a computing device to perform the acts of FIG. 10. In some embodiments, a system is configured to perform the acts of FIG. 10. Alternatively, the acts of FIG. 10 are performed as part of a computer-implemented method.

FIG. 10 illustrates a flowchart of a series of acts for generating a predicted document-summary consistency for a digital summary of a digital document in accordance with one or more embodiments. While FIG. 10 illustrates acts according to one embodiment, alternative embodiments omit, add to, reorder, and/or modify any acts shown in FIG. 10.

FIG. 10 illustrates an example series of acts 1000 for utilizing a factual inconsistency detection system 106 to generate a predicted document-summary consistency. In particular, in certain embodiments, the series of acts 1000 includes an act 1002 of generating atomic facts from a digital summary of a digital document. Specifically, in one or more embodiments, the act 1002 includes generating, utilizing a large language model, atomic facts from a digital summary of a digital document. In particular, in certain embodiments, the series of acts 1000 includes an act 1004 of generating localized relationship scores by comparing an atomic fact with sentences of the digital document. In particular, in one or more embodiments, the act 1004 includes generating, utilizing a natural language inference model, localized relationship scores by comparing an atomic fact of the atomic facts with sentences of the digital document. As illustrated, in some embodiments, the series of acts 1000 also includes an act 1006 of generating granularity expanded relationship scores by comparing the atomic fact with a plurality of sentences of the digital document. In particular, in one or more embodiments, the act 1006 includes generating, utilizing the natural language inference model, granularity expanded relationship scores by comparing the atomic fact with a plurality of granularity expanded sentence combinations from the digital document. In certain embodiments, the series of acts 1000 also includes an act 1008 of generating a predicted document-summary consistency from the localized relationship scores and the granularity expanded relationship scores. In particular, in one or more embodiments, the act 1008 includes generating a predicted document-summary consistency between the digital summary and the digital document from the localized relationship scores and the granularity expanded relationship scores.

In addition (or in the alternative) to the acts described above, in certain embodiments, the factual inconsistency detection system series of acts 1000 also includes generating a combined localized relationship score for the atomic fact from the localized relationship scores. In some embodiments, the series of acts 1000 also includes generating a combined granularity expanded relationship score for the atomic fact from the granularity expanded relationship scores. Moreover, in one or more embodiments, the factual inconsistency detection system 106 series of acts 1000 includes generating an overall consistency score for the atomic fact based on the combined localized relationship score and the combined granularity expanded relationship score.

Further still, in some embodiments, the factual inconsistency detection system 106 series of acts 1000 includes generating an additional overall consistency score for an additional atomic fact from the atomic facts. Furthermore, in one or more embodiments, the factual inconsistency detection system series of acts 1000 includes generating the predicted document-summary consistency from the overall consistency score for the atomic fact and the additional overall consistency score for the additional atomic fact. Moreover, one or more embodiments, the series of acts 1000 includes generating, utilizing the natural language inference model, additional localized relationship scores for the additional atomic fact by comparing the additional atomic fact with the sentences of the digital document. Further still, in one or more embodiments, the series of acts 1000 includes generating the additional overall consistency score for the additional atomic fact from the additional localized relationship scores.

Moreover, in one or more embodiments, the series of acts 1000 includes generating, utilizing a coreference resolution model, the digital document by replacing pronouns within a digital source document with entity names, or prefixing modifiers within the digital source document with entity names. In certain embodiments, the series of acts 1000 further includes generating, utilizing the coreference resolution model, the digital summary by replacing pronouns within a digital source summary of the digital source document with entity names, or prefixing modifiers within the digital source summary with entity names.

Moreover, one or more embodiments, the series of acts 1000 includes generating, utilizing the large language model, an initial set of atomic facts from the digital summary. Furthermore, in one or more embodiments, the series of acts 1000 includes comparing, utilizing the natural language inference model, the initial set of atomic facts to the digital summary to generate a plurality of summary relationship scores between the initial set of atomic facts and the digital summary. Moreover, in one or more embodiments, the series of acts 1000 includes selecting the atomic facts as a subset of the initial set of atomic facts based on the plurality of summary relationship scores.

In one or more embodiments, the series of acts 1000 includes comparing the atomic fact with a first set of granularity expanded sentence combinations comprising adjacent sentence combinations within a first sentence threshold to generate a first set of granularity expanded relationship scores. Further still, in one or more embodiments, the series of acts 1000 includes comparing the atomic fact with a second set of granularity expanded sentence combinations comprising adjacent sentence combinations within a second sentence threshold different than the first sentence threshold to generate a second set of granularity expanded relationship scores. In one or more embodiments, the series of acts 1000 further includes generating the localized relationship scores by generating an entailment score for the atomic fact. In addition, in one or more embodiments, the series of acts 1000 includes generating the granularity expanded relationship scores based on comparing the entailment score to a contradiction score and a neutral score for the atomic fact.

Furthermore, in one or more embodiments, the series of acts 1000 includes generating, utilizing a coreference resolution model, a coreference resolved digital document from a digital document. In addition, in one or more embodiments, the series of acts 1000 includes generating, utilizing the coreference resolution model, a coreference resolved digital summary from a digital summary of the digital document. Moreover, in one or more embodiments, the series of acts 1000 includes generating, utilizing a large language model, atomic facts from the coreference resolved digital summary. In one or more embodiments, the series of acts 1000 includes generating, utilizing a natural language inference model, localized relationship scores and granularity expanded relationship scores from the atomic facts and the coreference resolved digital document. Furthermore, in one or more embodiments, the series of acts 1000 includes generating a predicted document-summary consistency between the digital summary and the digital document from the localized relationship scores and the granularity expanded relationship scores.

In some embodiments, the series of acts 1000 also includes generating a set of combined localized relationship scores for the atomic facts from the localized relationship scores. Moreover, in one or more embodiments, the factual inconsistency detection system 106 series of acts 1000 includes generating a set of overall consistency scores for the atomic facts from the set of combined localized relationship scores and the granularity expanded relationship scores. Further still, in some embodiments, the factual inconsistency detection system 106 series of acts 1000 includes generating the predicted document-summary consistency from the set of overall consistency scores.

Furthermore, in one or more embodiments, the factual inconsistency detection system series of acts 1000 includes, based on determining a subset of the set of combined localized relationship scores fails to satisfy a relationship threshold for the coreference resolved digital document, generating the granularity expanded relationship scores for the atomic facts. Moreover, one or more embodiments, the series of acts 1000 includes generating a first overall consistency score for a first atomic fact based on a first combined localized relationship score and the granularity expanded relationship scores. Further still, in one or more embodiments, the series of acts 1000 includes generating a second overall consistency score for a second atomic fact based on a second combined localized relationship score. Moreover, in one or more embodiments, the series of acts 1000 includes generating the set of overall consistency scores from the first overall consistency score for the first atomic fact and the second overall consistency score for the second atomic fact.

In certain embodiments, the series of acts 1000 further includes selecting a plurality of granularity expanded sentence combinations from the coreference resolved digital document. Moreover, one or more embodiments, the series of acts 1000 includes comparing an atomic fact with the plurality of granularity expanded sentence combinations. Moreover, one or more embodiments, the series of acts 1000 includes generating an initial set of atomic facts from the coreference resolved digital summary. Furthermore, in one or more embodiments, the series of acts 1000 includes selecting, utilizing the natural language inference model, the atomic facts as a subset of the initial set of atomic facts based on a comparison of the initial set of atomic facts to sentences of the digital summary.

Moreover, in one or more embodiments, the series of acts 1000 includes generating, utilizing a natural language inference model, a first set of localized relationship scores between a first atomic fact extracted from a digital summary of a digital document and sentences of the digital document.

In one or more embodiments, the series of acts 1000 includes generating, utilizing the natural language inference model, a second set of localized relationship scores between a second atomic fact extracted from the digital summary and the sentences of the digital document. Further still, in one or more embodiments, the series of acts 1000 includes, upon determining that the first set of localized relationship scores fail to satisfy a relationship threshold, generating, utilizing the natural language inference model, granularity expanded relationship scores by comparing the first atomic fact with granularity expanded sentence combinations from the digital document. In one or more embodiments, the series of acts 1000 further generating a predicted document-summary consistency between the digital summary and the digital document from the granularity expanded relationship scores and the second set of localized relationship scores.

In addition, in one or more embodiments, the series of acts 1000 includes modifying the digital document by replacing pronouns with entity names within the digital document or adding entity names modifiers within the digital document. Furthermore, in one or more embodiments, the series of acts 1000 includes modifying the digital summary by replacing pronouns with entity names within the digital summary or adding entity names to modifiers within the digital summary.

In addition, in one or more embodiments, the series of acts 1000 includes generating atomic facts comprising the first atomic fact and the second atomic fact. Moreover, in one or more embodiments, the series of acts 1000 includes restricting an entity count of the first atomic fact and an entity count of the second atomic fact. In one or more embodiments, the series of acts 1000 includes generating an initial set of atomic facts from the digital summary. Furthermore, in one or more embodiments, the series of acts 1000 includes comparing the initial set of atomic facts to the digital summary to generate a plurality of summary relationship scores between the initial set of atomic facts and the digital summary. In some embodiments, the series of acts 1000 also includes selecting the atomic facts as a subset of the initial set of atomic facts based on the plurality of summary relationship scores.

Moreover, in one or more embodiments, the factual inconsistency detection system 106 series of acts 1000 includes comparing the first atomic fact with a first set of granularity expanded sentence combinations comprising adjacent sentence combinations within a first sentence threshold to generate a first set of granularity expanded relationship scores. Further still, in some embodiments, the factual inconsistency detection system 106 series of acts 1000 includes comparing the first atomic fact with a second set of granularity expanded sentence combinations comprising adjacent sentence combinations within a second sentence threshold to generate a second set of granularity expanded relationship scores. Furthermore, in one or more embodiments, the factual inconsistency detection system series of acts 1000 includes combining the first set of granularity expanded relationship scores and the second set of granularity expanded relationship scores.

Additionally, one or more embodiments, the series of acts 1000 includes generating the first set of localized relationship scores by generating a set of entailment scores for the first atomic fact based on a comparison of the first atomic fact to the sentences of the digital document. Further still, in one or more embodiments, the series of acts 1000 includes generating the second set of localized relationship scores by generating a set of entailment scores for the second atomic fact based on a comparison of the second atomic fact to the sentences of the digital document.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 11 illustrates a block diagram of an example computing device 1100 that may be configured to perform one or more of the processes described above. One will appreciate that one or more computing devices, such as the computing device 1100 may represent the computing devices described above (e.g., server device(s) 102, client device(s) 110, and computing device 1100). In one or more embodiments, the computing device 1100 may be a mobile device (e.g., a mobile telephone, a smartphone, a PDA, a tablet, a laptop, a camera, a tracker, a watch, a wearable device, etc.). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular embodiment.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
generating, utilizing a large language model, atomic facts from a digital summary of a digital document;
generating, utilizing a natural language inference model, localized relationship scores by comparing an atomic fact of the atomic facts with sentences of the digital document;
generating, utilizing the natural language inference model, granularity expanded relationship scores by comparing the atomic fact with a plurality of granularity expanded sentence combinations from the digital document; and
generating a predicted document-summary consistency between the digital summary and the digital document from the localized relationship scores and the granularity expanded relationship scores.

2. The computer-implemented method of claim 1, wherein generating the predicted document-summary consistency between the digital summary and the digital document further comprises:
generating a combined localized relationship score for the atomic fact from the localized relationship scores;
generating a combined granularity expanded relationship score for the atomic fact from the granularity expanded relationship scores; and
generating an overall consistency score for the atomic fact based on the combined localized relationship score and the combined granularity expanded relationship score.

3. The computer-implemented method of claim 2, wherein generating the predicted document-summary consistency between the digital summary and the digital document further comprises:
generating an additional overall consistency score for an additional atomic fact from the atomic facts; and
generating the predicted document-summary consistency from the overall consistency score for the atomic fact and the additional overall consistency score for the additional atomic fact.

4. The computer-implemented method of claim 3, wherein generating the additional overall consistency score comprises:
generating, utilizing the natural language inference model, additional localized relationship scores for the additional atomic fact by comparing the additional atomic fact with the sentences of the digital document; and
generating the additional overall consistency score for the additional atomic fact from the additional localized relationship scores.

5. The computer-implemented method of claim 1, further comprising:
generating, utilizing a coreference resolution model, the digital document by:
replacing pronouns within a digital source document with entity names, or
prefixing modifiers within the digital source document with entity names; and
generating, utilizing the coreference resolution model, the digital summary by:
replacing pronouns within a digital source summary of the digital source document with entity names, or
prefixing modifiers within the digital source summary with entity names.

6. The computer-implemented method of claim 1, wherein generating the atomic facts comprises:
generating, utilizing the large language model, an initial set of atomic facts from the digital summary;
comparing, utilizing the natural language inference model, the initial set of atomic facts to the digital summary to generate a plurality of summary relationship scores between the initial set of atomic facts and the digital summary; and
selecting the atomic facts as a subset of the initial set of atomic facts based on the plurality of summary relationship scores.

7. The computer-implemented method of claim 1, wherein generating the granularity expanded relationship scores comprises:
comparing the atomic fact with a first set of granularity expanded sentence combinations comprising adjacent sentence combinations within a first sentence threshold to generate a first set of granularity expanded relationship scores; and
comparing the atomic fact with a second set of granularity expanded sentence combinations comprising adjacent sentence combinations within a second sentence threshold different than the first sentence threshold to generate a second set of granularity expanded relationship scores.

8. The computer-implemented method of claim 1, further comprising:
generating the localized relationship scores by generating an entailment score for the atomic fact; and
generating the granularity expanded relationship scores based on comparing the entailment score to a contradiction score and a neutral score for the atomic fact.

9. A system comprising:
one or more memory devices; and
one or more processors configured to cause the system to:
generate, utilizing a coreference resolution model, a coreference resolved digital document from a digital document;
generate, utilizing the coreference resolution model, a coreference resolved digital summary from a digital summary of the digital document;
generate, utilizing a large language model, atomic facts from the coreference resolved digital summary;
generate, utilizing a natural language inference model, localized relationship scores and granularity expanded relationship scores from the atomic facts and the coreference resolved digital document; and
generate a predicted document-summary consistency between the digital summary and the digital document from the localized relationship scores and the granularity expanded relationship scores.

10. The system of claim 9, further comprising:
generating a set of combined localized relationship scores for the atomic facts from the localized relationship scores;
generating a set of overall consistency scores for the atomic facts from the set of combined localized relationship scores and the granularity expanded relationship scores; and
generating the predicted document-summary consistency from the set of overall consistency scores.

11. The system of claim 10, further comprising based on determining a subset of the set of combined localized relationship scores fails to satisfy a relationship threshold for the coreference resolved digital document, generating the granularity expanded relationship scores for the atomic facts.

12. The system of claim 10, further comprising:
generating a first overall consistency score for a first atomic fact based on a first combined localized relationship score and the granularity expanded relationship scores;
generating a second overall consistency score for a second atomic fact based on a second combined localized relationship score; and
generating the set of overall consistency scores from the first overall consistency score for the first atomic fact and the second overall consistency score for the second atomic fact.

13. The system of claim 9, wherein generating, the granularity expanded relationship scores comprises:
selecting a plurality of granularity expanded sentence combinations from the coreference resolved digital document; and
comparing an atomic fact with the plurality of granularity expanded sentence combinations.

14. The system of claim 9, further comprising:
generating an initial set of atomic facts from the coreference resolved digital summary; and
selecting, utilizing the natural language inference model, the atomic facts as a subset of the initial set of atomic facts based on a comparison of the initial set of atomic facts to sentences of the digital summary.

15. A non-transitory computer readable medium storing executable instructions which, when executed by a processing device, cause the processing device to perform operations comprising:
generating, utilizing a natural language inference model, a first set of localized relationship scores between a first atomic fact extracted from a digital summary of a digital document and sentences of the digital document;
generating, utilizing the natural language inference model, a second set of localized relationship scores between a second atomic fact extracted from the digital summary and the sentences of the digital document;
upon determining that the first set of localized relationship scores fail to satisfy a relationship threshold, generating, utilizing the natural language inference model, granularity expanded relationship scores by comparing the first atomic fact with granularity expanded sentence combinations from the digital document; and
generating a predicted document-summary consistency between the digital summary and the digital document from the granularity expanded relationship scores and the second set of localized relationship scores.

16. The non-transitory computer readable medium of claim 15, further comprising:
modifying the digital document by:
replacing pronouns with entity names within the digital document, or
adding entity names modifiers within the digital document; and
modifying the digital summary by:
replacing pronouns with entity names within the digital summary, or
adding entity names to modifiers within the digital summary.

17. The non-transitory computer readable medium of claim 15, further comprising:
generating atomic facts comprising the first atomic fact and the second atomic fact; and
restricting an entity count of the first atomic fact and an entity count of the second atomic fact.

18. The non-transitory computer readable medium of claim 17, further comprising:
generating an initial set of atomic facts from the digital summary;
comparing the initial set of atomic facts to the digital summary to generate a plurality of summary relationship scores between the initial set of atomic facts and the digital summary; and
selecting the atomic facts as a subset of the initial set of atomic facts based on the plurality of summary relationship scores.

19. The non-transitory computer readable medium of claim 15, generating the granularity expanded relationship scores comprises:
comparing the first atomic fact with a first set of granularity expanded sentence combinations comprising adjacent sentence combinations within a first sentence threshold to generate a first set of granularity expanded relationship scores;
comparing the first atomic fact with a second set of granularity expanded sentence combinations comprising adjacent sentence combinations within a second sentence threshold to generate a second set of granularity expanded relationship scores; and
combining the first set of granularity expanded relationship scores and the second set of granularity expanded relationship scores.

20. The non-transitory computer readable medium of claim 15, further comprising:
generating the first set of localized relationship scores by generating a set of entailment scores for the first atomic fact based on a comparison of the first atomic fact to the sentences of the digital document; and
generating the second set of localized relationship scores by generating a set of entailment scores for the second atomic fact based on a comparison of the second atomic fact to the sentences of the digital document.
